(19) United States
(12) Patent Application Publication
(10) Pub. No.: US 2026/0075515 A1
(43) Pub. Date: Mar. 12, 2026

(54) ELECTRONIC DEVICE SUPPORTING NON-TERRESTRIAL NETWORK COMMUNICATION AND METHOD FOR OPERATING THE SAME

(71) Applicant: Samsung Electronics Co., Ltd., Suwon-si (KR)

(72) Inventors: Namkyeom KIM, Suwon-si (KR); Nohsun KIM, Suwon-si (KR); Haryun LEE, Suwon-si (KR); Hyunchul LEE, Suwon-si (KR)

(21) Appl. No.: 19/323,892

(22) Filed: Sep. 9, 2025

Related U.S. Application Data
(63) Continuation of application No. PCT/KR2025/013793, filed on Sep. 5, 2025.

(30) Foreign Application Priority Data
Sep. 10, 2024 (KR) 10-2024-0123521
Oct. 21, 2024 (KR) 10-2024-0144190

(51) Int. Cl. H04W 48/20; H04W 48/16; H04W 60/00; H04W 76/50; H04W 84/06

(52) U.S. Cl. CPC H04W 48/20; H04W 48/16; H04W 60/005; H04W 76/50; H04W 84/06

(57) ABSTRACT

An electronic device may comprise at least one processor, comprising processing circuitry, and memory storing instructions. At least one processor, individually or collectively, may be configured to execute the instructions and to cause the electronic device to, in a state in which a first SIM is connected to the at least one processor, access a first cell of a non-terrestrial network in which the electronic device is capable of registering, using information stored in the first SIM and a first protocol stack among a plurality of protocol stacks for a plurality of SIMs, based on accessing the first cell of the NTN, perform a scan using a second protocol stack different from the first protocol stack among the plurality of protocol stacks, in a state in which a SIM for the second protocol stack is not connected to the one or more processors, based on a result of the scan, identify a second cell of a terrestrial network, based on a cell selection criterion associated with the second cell being satisfied in the state in which the SIM for the second protocol stack is not connected to the one or more processors, camp on the second cell by performing any cell selection associated with the second cell, and in a state in which the electronic device performs NTN communication based on the first cell and camps on the second cell, receive, from the second cell, an emergency message by a network corresponding to the second cell. Other various embodiments are possible as well.

### CROSS-REFERENCE TO RELATED APPLICATIONS

This application is a continuation of International Application No. PCT/KR2025/013793 designating the United States, filed on Sep. 5, 2025, in the Korean Intellectual Property Receiving Office and claiming priority to Korean Patent Application Nos. 10-2024-0123521, filed on Sep. 10, 2024, and 10-2024-0144190, filed on Oct. 21, 2024, in the Korean Intellectual Property Office, the disclosures of each of which are incorporated by reference herein in their entireties.

### BACKGROUND

### Field

The disclosure relates to an electronic device supporting non-terrestrial network communication and a method for operating the same.

### Description of Related Art

Recently, electronic devices supporting non-terrestrial network communication (e.g., satellite communication) are being actively introduced. As an example, an electronic device may communicate with a satellite of a satellite communication company using the frequency and communication scheme of the company. As an example, an electronic device may communicate with a satellite using a long-term evolution (LTE) standard cellular frequency based on the LTE standard (or 5G standard). As an example, an electronic device may communicate with a satellite based on the 5G non-terrestrial networks (NTN) standard.

For example, when an electronic device communicates with a non-terrestrial network based on the LTE standard, some of the frequencies defined in the LTE standard may be allocated for non-terrestrial communication. An electronic device may perform satellite communication using a protocol stack used in terrestrial communication and may require no further protocol stack for non-terrestrial communication. Electronic devices may perform communication without distinguishing between non-terrestrial communication and terrestrial communication. For example, the electronic device may perform a cell scan, camp on a cell that meets cell selection criteria, and access the network (which may include a camp-on procedure, a random access (RA) procedure, a connection establishment procedure, and/or attaching (which may include registration)). The electronic device may perform operations for camping on to a cell that meets the cell selection criteria and accessing the network, without distinguishing between non-terrestrial communication and terrestrial communication. Accordingly, the electronic device may prepare to perform non-terrestrial communication in a scheme that is substantially the same as terrestrial communication.

In a wireless communication system, an electronic device (e.g., user equipment (UE)) may access a wireless communication network and use a voice communication or data communication service in a fixed position or on the move. To provide a communication service to an electronic device, an appropriate authentication process is required. A universal integrated circuit card (UICC) is inserted into the electronic device, and authentication is performed between the electronic device and the server of the mobile network operator (MNO) through a universal subscriber identity module (USIM) installed in the UICC. UICC may be called subscriber identity module (SIM) in the case of global system for mobile communications (GSM) and universal subscriber identity module (USIM) in the case of wideband code division multiple access (WCDMA), and long term evolution (LTE). The USIM card or SIM card may be provided as a standalone UICC or may be embedded (e.g., embedded SIM, eSIM) in the electronic device or may be integrated into at least one chip included in the electronic device (e.g., integrated SIM, iSIM).

If the user of the electronic device subscribes to a wireless communication service provided by the mobile network operator, the mobile network operator may provide a UICC (e.g., a SIM card or a USIM card) to the user. The user may insert the provided UICC into her electronic device. When the user of the electronic device subscribes to the wireless communication service provided by the mobile network operator, the user may receive information to be stored in the UICC (e.g., eSIM card or iSIM card) included in the electronic device from the mobile network operator. If the UICC is inserted into the electronic device or the information to be stored in the UICC is received from the mobile network operator, the USIM application installed in the UICC may perform an appropriate authentication process with the mobile network operator's server, which stores the same value, using to the international mobile subscriber identity (IMSI) value stored in the UICC and the encryption key value for authentication. After the appropriate authentication process is performed, the wireless communication service may be used.

When information related to the SIM is provided to the UICC (e.g., eSIM or iSIM) installed in the electronic device from the server of the mobile network operator, an appropriate authentication process may be performed with the mobile network operator's server that stores the same value using an encryption key value for authentication and the international mobile subscriber identity (IMSI) value that may be generated through information related to the SIM or included in the SIM-related information. After the appropriate authentication process is performed, the wireless communication service may be used.

The electronic device may support two or more SIMs, which may be referred to as a dual-SIM or multi-SIM electronic device. Mounting two or more SIM cards in an electronic device may refer to at least two or more independent UICCs being configured. Or, mounting two or more SIM cards in an electronic device may refer to at least one or more independent UICCs and at least one or more eSIM cards being configured. Or, mounting two or more SIM cards in an electronic device may refer to at least one or more independent UICCs and at least one or more iSIM card being configured. Or, mounting two or more SIM cards in an electronic device may refer to an eSIM card or iSIM card supporting at least two or more networks being configured.

### SUMMARY

According to an example embodiment electronic device may comprise one or more processors, comprising processing circuitry, and memory storing instructions.

At least one processor, individually or collectively, may be configured to execute the instructions and to cause the electronic device to: in a state in which a first subscriber identity module (SIM) is connected to at least one processor, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

At least one processor individually or collectively executed may be configured to cause the electronic device to, based on accessing the first cell of the NTN, perform a scan using a second protocol stack different from the first protocol stack among the plurality of protocol stacks, in a state in which a SIM for the second protocol stack is not connected to the one or more processors.

At least one processor, individually or collectively, may be configured to cause the electronic device to, based on a result of the scan, identify a second cell of a terrestrial network (TN).

At least one processor, individually or collectively, may be configured to cause the electronic device to, based on a cell selection criterion associated with the second cell being satisfied in the state in which the SIM for the second protocol stack is not connected to at least one processor, camp on the second cell by performing any cell selection associated with the second cell.

At least one processor, individually or collectively, may be configured to cause the electronic device to, in a state in which the electronic device performs NTN communication based on the first cell and camps on the second cell, receive, from the second cell, an emergency message by a network corresponding to the second cell.

According to an example embodiments, a method for operating an electronic device may be provided.

The method of operating the electronic device may comprise: in a state in which a first subscriber identity module (SIM) is connected to at least on processor, comprising processing circuitry, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of an SIM associated with a remaining protocol stack except for the first protocol stack among the plurality of protocol stacks, an operation associated with the remaining protocol stack may be deactivated. Provision of an emergency message based on the first cell of the NTN may not be supported.

The method of operating the electronic device may comprise, based on accessing the first cell of the NTN, performing a scan using a second protocol stack different from the first protocol stack among the plurality of protocol stacks, in a state in which a SIM for the second protocol stack is not connected to the one or more processors.

The method of operating the electronic device may comprise identifying a second cell of the TN.

The method of operating the electronic device may comprise, based on a cell selection criterion associated with the second cell being satisfied in the state in which the SIM for the second protocol stack is not connected to at least one processor, camping on the second cell by performing any cell selection associated with the second cell.

The method of operating the electronic device may comprise, in a state in which the electronic device performs NTN communication based on the first cell and camps on the second cell, receiving, from the second cell, an emergency message by a network corresponding to the second cell.

According to an example embodiment, there may be provided a non-transitory computer-readable storage medium storing instructions.

The instructions may, when executed by at least one processor, comprising processing circuitry, individually and/or collectively, of an electronic device, cause the electronic device to: in a state in which a first subscriber identity module (SIM) is connected to at least one processor, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The instructions, when executed by at least one processor, comprising processing circuitry of an electronic device, may cause the electronic device to, based on accessing the first cell of the NTN, perform a scan using a second protocol stack different from the first protocol stack among the plurality of protocol stacks, in a state in which a SIM for the second protocol stack is not connected to the one or more processors.

The instructions, when executed by at least one processor, comprising processing circuitry, individually or collectively, cause the electronic device to, based on a result of the scan, identify a second cell of a terrestrial network TN.

The instructions may, when executed by at least one processor, comprising processing circuitry, individually or collectively, cause the electronic device to, based on a cell selection criterion associated with the second cell being satisfied in the state in which the SIM for the second protocol stack is not connected to at least one processor, camp on the second cell by performing any cell selection associated with the second cell.

The instructions may, when executed by at least one processor, comprising processing circuitry, individually or collectively, cause the electronic device to, in a state in which the electronic device performs NTN communication based on the first cell and camps on the second cell, receive, from the second cell, an emergency message by a network corresponding to the second cell.

According to an example embodiment, an electronic device may comprise an embedded SIM, at least one processor, comprising processing circuitry, and memory storing instructions.

At least one processor, individually or collectively, may be configured to executed the instructions, and to cause the electronic device to: in a state in which a first (SIM) is connected to at least one processor or a first profile based on the embedded SIM is activated, access a first cell of a non-terrestrial network (NTN) in which the electronic device is capable of registering, using information stored in the first SIM or the first profile and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

At least one processor, individually or collectively, may be configured to cause the electronic device to: based on accessing the first cell of the NTN, perform a scan using a second protocol stack different from the first protocol stack among the plurality of protocol stacks, in a state in which a profile for the second protocol stack is not activated based on the embedded SIM.

At least one processor, individually or collectively, may be configured to cause the electronic device to, based on a result of the scan, identify a second cell of a terrestrial network (TN).

At least one processor, individually or collectively, may be configured to cause the electronic device to, based on a cell selection criterion associated with the second cell being satisfied in the state in which the profile corresponding to the second cell is not activated based on the embedded SIM, camp on the second cell by performing any cell selection associated with the second cell.

At least one processor, individually or collectively, may be configured to cause the electronic device to, in a state in which the electronic device performs NTN communication based on the first cell and camps on the second cell, receive, from the second cell, an emergency message by a network corresponding to the second cell.

According to an example embodiment, a method of operating an electronic device may be provided.

The method of operating the electronic device may comprise, in a state in which a first (SIM) is connected to at least one processor or a first profile based on the embedded SIM is activated, accessing a first cell of a non-terrestrial network (NTN) in which the electronic device is capable of registering, using information stored in the first SIM or the first profile and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The method of operating the electronic device may comprise, based on accessing the first cell of the NTN, performing a scan using a second protocol stack different from the first protocol stack among the plurality of protocol stacks, in a state in which a profile for the second protocol stack is not activated based on the embedded SIM.

The method of operating the electronic device may comprise identifying a second cell of the TN.

The method of operating the electronic device may comprise, based on a cell selection criterion associated with the second cell being satisfied in the state in which a profile corresponding to the second cell is not activated based on the embedded SIM, camping on the second cell by performing any cell selection associated with the second cell.

The method of operating the electronic device may comprise, in a state in which the electronic device performs NTN communication based on the first cell and camps on the second cell, receiving, from the second cell, an emergency message by a network corresponding to the second cell.

According to an example embodiment, there may be provided a non-transitory computer-readable storage medium storing instructions.

The instructions may, when executed by at least one processor, comprising processing circuitry, individually or collectively, of an electronic device, cause the electronic device to, in a state in which a first (SIM) is connected to at least one processor or a first profile based on the embedded SIM is activated, access a first cell of a non-terrestrial network (NTN) in which the electronic device is capable of registering, using information stored in the first SIM or the first profile and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The instructions may, when executed by at least one processor, individually or collectively, cause the electronic device to, based on accessing the first cell of the NTN, perform a scan using a second protocol stack different from the first protocol stack among the plurality of protocol stacks, in a state in which a profile for the second protocol stack is not activated based on the embedded SIM.

The instructions may, when executed by at least one processor, individually or collectively, cause the electronic device to, based on a result of the scan, identify a second cell of a terrestrial network (TN).

The instructions may, when executed by at least one processor, individually or collectively, cause the electronic device to, based on a cell selection criterion associated with the second cell being satisfied in the state in which the profile corresponding to the second cell is not activated based on the embedded SIM, camp on the second cell by performing any cell selection associated with the second cell.

The instructions may, when executed by at least one processor, individually or collectively, cause the electronic device to, in a state in which the electronic device performs NTN communication based on the first cell and camps on the second cell, receive, from the second cell, an emergency message by a network corresponding to the second cell.

According to an example embodiment, an electronic device may comprise at least one processor, comprising processing circuitry, and memory storing instructions.

At least one processor, individually or collectively, may be configured to cause the electronic device to, in a state in which a first subscriber identity module (SIM) is connected to the one or more processors, access a first cell of a non-terrestrial network NTN in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. An emergency call based on the first cell of the NTN may not be supported.

At least one processor, individually or collectively, may be configured to cause the electronic device to, based on accessing the first cell of the NTN, perform a scan using a second protocol stack different from the first protocol stack among the plurality of protocol stacks, in a state in which a SIM for the second protocol stack is not connected to the one or more processors.

At least one processor, individually or collectively, may be configured to cause the electronic device to, based on a result of the scan, identify a second cell of a terrestrial network (TN).

At least one processor, individually or collectively, may be configured to cause the electronic device to, based on a cell selection criterion associated with the second cell being satisfied in the state in which the SIM for the second protocol stack is not connected to the one or more processors, camp on the second cell by performing any cell selection associated with the second cell.

At least one processor, individually or collectively, may be configured to cause the electronic device to, in the state in which the electronic device performs the NTN communication based on the first cell and camps on the second cell, perform the emergency call based on the second cell.

According to an example embodiment, a method for operating an electronic device may be provided.

The method of operating the electronic device may comprise, in a state in which a first subscriber identity module (SIM) is connected to at least one processor, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. An emergency call based on the first cell of the NTN may not be supported.

The method of operating the electronic device may comprise, based on accessing the first cell of the NTN, performing a scan using a second protocol stack different from the first protocol stack among the plurality of protocol stacks, in a state in which a SIM for the second protocol stack is not connected to the one or more processors.

The method of operating the electronic device may comprise identifying a second cell of the TN.

The method of operating the electronic device may comprise, based on a cell selection criterion associated with the second cell being satisfied in the state in which the SIM for the second protocol stack is not connected to at least one processor, camping on the second cell by performing any cell selection associated with the second cell.

The method of operating the electronic device may comprise, in the state in which the electronic device performs the NTN communication based on the first cell and camps on the second cell, performing the emergency call based on the second cell.

According to an example embodiment, may be provided a non-transitory computer-readable storage medium storing instructions.

The instructions may, when executed by at least one processor, comprising processing circuitry, individually or collectively, of an electronic device, cause the electronic device to, in a state in which a first subscriber identity module (SIM) is connected to at least one processor, access a first cell of a non-terrestrial network NTN in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. An emergency call based on the first cell of the NTN may not be supported.

The instructions may, when executed by at least one processor, individually or, cause the electronic device to, based on accessing the first cell of the NTN, perform a scan using a second protocol stack different from the first protocol stack among the plurality of protocol stacks, in a state in which a SIM for the second protocol stack is not connected to the one or more processors.

The instructions may, when executed by at least on processor, individually or, cause the electronic device to, based on a result of the scan, identify a second cell of a terrestrial network TN.

The instructions may, when executed by at least one processor, individually or, cause the electronic device to, based on a cell selection criterion associated with the second cell being satisfied in the state in which the SIM for the second protocol stack is not connected to the one or more processors, camp on the second cell by performing any cell selection associated with the second cell.

The instructions may, when executed by at least one processor, individually or collectively, cause the electronic device to, in the state in which the electronic device performs the NTN communication based on the first cell and camps on the second cell, perform the emergency call based on the second cell.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a block diagram illustrating an example electronic device in a network environment according to various embodiments;

FIG. 1B is a diagram illustrating an example network environment including an electronic device according to various embodiments;

FIG. 2 is a diagram illustrating an example configuration of an electronic device and a long-range communication network environment according to various embodiments;

FIG. 3 is a diagram illustrating access to an electronic device according to various embodiments;

FIG. 4 is a diagram illustrating an example non-terrestrial network system according to various embodiments;

FIG. 5 is a block diagram illustrating an example configuration of an electronic device according to various embodiments;

FIG. 6A is a flowchart illustrating an example method of operating an electronic device according to various embodiments;

FIG. 6B is a diagram illustrating a cell of a non-terrestrial network and a cell of a terrestrial network according to various embodiments;

FIG. 7 is a signal flow diagram illustrating an example method of operating an electronic device according to various embodiments;

FIG. 8A is a flowchart illustrating an example method of operating an electronic device according to various embodiments;

FIG. 8B is a flowchart illustrating an example method of operating an electronic device according to various embodiments;

FIG. 9A is a flowchart illustrating an example method of operating an electronic device according to various embodiments;

FIG. 9B is a diagram illustrating a cell of a non-terrestrial network and a cell of a terrestrial network according to various embodiments;

FIG. 10A is a flowchart illustrating an example method of operating an electronic device according to various embodiments;

FIG. 10B is a flowchart illustrating an example method of operating an electronic device according to various embodiments;

FIG. 11 is a flowchart illustrating an example method of operating an electronic device according to various embodiments;

FIG. 12 is a flowchart illustrating an example method of operating an electronic device according to various embodiments;

FIG. 13 is a flowchart illustrating an example method of operating an electronic device according to various embodiments;

FIG. 14A is a flowchart illustrating an example method of operating an electronic device according to various embodiments;

FIG. 14B is a flowchart illustrating an example method of operating an electronic device according to various embodiments;

FIGS. 15A and 15B are diagrams illustrating example screens displayed by an electronic device according to various embodiments; and

FIG. 16 is a flowchart illustrating an example method of operating an electronic device according to various embodiments.

### DETAILED DESCRIPTION

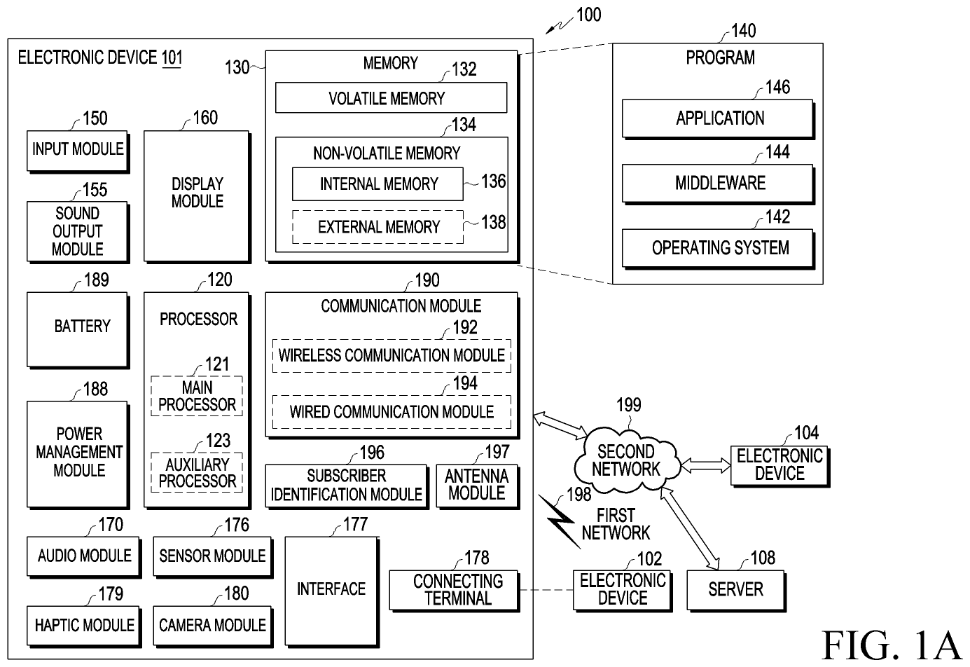

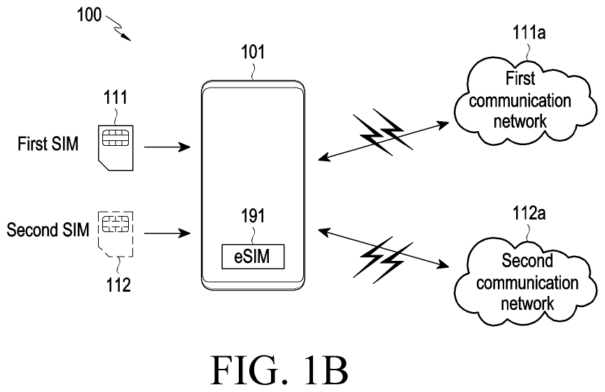

FIG. 1A is a block diagram illustrating an example electronic device 101 in a network environment 100 according to various embodiments. Referring to FIG. 1A, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 1B is a diagram illustrating an example network environment 100 including an electronic device according to various embodiments. Referring to FIG. 1B, according to various embodiments of the disclosure, a network 100 may include an electronic device 101, a first communication network 111a, a second communication network 112a, and/or a third communication network (not shown).

In an embodiment, the electronic device 101 may be equipped with two SIMs, e.g., a first SIM 111 and/or a second SIM 112. The first SIM 111 and the second SIM 112 may be removable SIMs (rSIMs). The rSIM may be a SIM detachable from a slot provided in the electronic device 101 and its form/specifications are not limited to specific ones. For example, the electronic device 101 may be equipped with two SIM cards to support the two SIMs. According to an embodiment, for convenience of description, the first SIM 111 and the second SIM 112 are shown as SIM cards, but are not limited thereto. The electronic device 101 may include an embedded SIM (eSIM) 191. For example, the electronic device 101 may be implemented to include only the eSIM 191, and the eSIM 191 may activate a plurality of profiles. In this case, a dual SIM-based operation based on the plurality of profiles may be performed. The electronic device 101 may be implemented to include the eSIM 191 and a slot for mounting one or more SIMs. In this case, the electronic device 101 may perform the dual SIM-based operation based on information stored in an rSIM inserted (or connected) in the slot and the profile activated by the eSIM 191. The electronic device 101 may perform dual SIM-based operations based on two rSIMs, and the combination is not limited. For example, at least one of the first SIM 111 or the second SIM 112 may be replaced with an eSIM or an integrated SIM (iSIM). In this case, at least part of the information stored in the rSIM may be replaced by information about the profile activated by the eSIM. Hereinafter, for convenience of description, the SIM card will be referred to as a SIM. As illustrated in FIG. 1B, only the first SIM 111 may be mounted in the electronic device 101, but no separate SIM may be mounted in the slot for the second SIM 112. The electronic device 101 may include a first slot (not shown) and a second slot (not shown), which are structures, to receive the first SIM 111 and the second SIM 112, respectively. In this case, the first slot may receive a first SIM 111, while the second slot may not receive a separate external object.

For example, the first SIM 111 is a SIM subscribed to a communication operator of a first communication network 111a, and the electronic device 101 may connect to the first communication network 111a using the first SIM 111, thereby receiving wireless communication services, e.g., using a protocol stack for the first slot and the information stored in the first SIM 111. Since no separate SIM is mounted in the second slot, in general circumstances, operations associated with the protocol stack for the second slot may be deactivated (or not performed). As will be described below, the electronic device 101 according to an embodiment may, in response to the occurrence of a designated trigger (e.g., connection to the cell of the NTN based on the first SIM 111), perform a scanning operation, a limited camp-on operation, and/or emergency services (e.g., reception of emergency messages and/or emergency calls) through the limited camp-on operation using the protocol stack for the second slot, even when a separate SIM is not connected to the second slot. Accordingly, emergency services through the second communication network 112a may be performed even in the absence of information about a SIM corresponding to the second communication network 112a, which is described below. The first communication network 111a and the second communication network 112a may be provided by different operators, but the disclosure is not limited thereto. For example, a first mobile network operator may use the first communication network 111a, and a second mobile network operator may be configured to also use the second communication network 111a. According to an embodiment, although not shown, one of ordinary skill in the art will understand that the electronic device 101 may further include at least one additional SIM, and the number or type of SIMs is not limited.

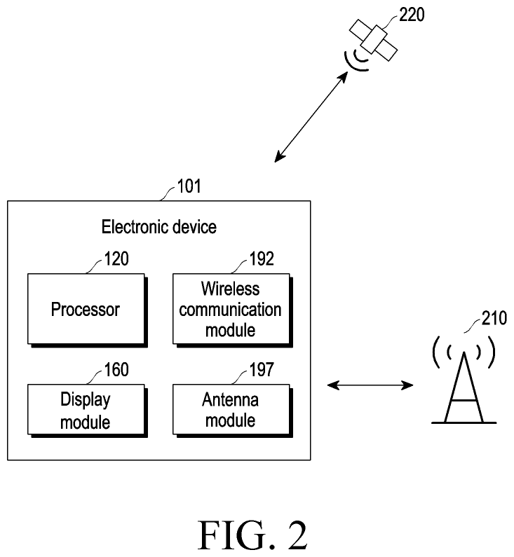

FIG. 2 is a diagram including a block diagram illustrating an example configuration of an electronic device and a long-range communication network environment according to various embodiments.

The electronic device 101 may transmit and/or receive data through a terrestrial network and/or a non-terrestrial network. The electronic device 101 may have the same or similar configuration of the electronic device 101 illustrated in FIG. 1 or may include the configuration of the electronic device 101 illustrated in FIG. 1.

The terrestrial network may refer to a network capable of providing data communication through the terrestrial wireless communication device 210. For example, the terrestrial wireless communication device 210 may include a base station positioned on the ground (e.g., fixed to the ground). The terrestrial wireless communication device 210 may support at least one of various communication schemes supportable by the electronic device 101. For example, the terrestrial wireless communication device 210 may include an eNodeB (e.g., an LTE-based base station) or a gNodeB (e.g., a 5G (or NR)-based base station), but is not limited thereto.

The non-terrestrial network may refer to a network capable of providing data communication through at least one non-terrestrial wireless communication device 220. For example, the non-terrestrial wireless communication device 220 may include at least one of various communication devices such as a base station and a repeater that are not positioned on the ground. For example, the non-terrestrial wireless communication device 220 may include a satellite and/or an unmanned aerial vehicle, but is not limited thereto. For example, the satellite may include a low-earth orbit (LEO) satellite, a medium-earth orbit (MEO) satellite, a geostationary earth orbit (GEO) satellite, and/or a high elliptical orbit (HEO) satellite. For example, the satellite may include an orbiting satellite and/or a geostationary satellite.

The non-terrestrial wireless communication device 220 may support at least one of various wireless communication schemes. For example, the non-terrestrial wireless communication device 220 may support a non-terrestrial network (NR NTN) defined by 3rd generation partnership project (3GPP). Alternatively, the non-terrestrial wireless communication device 220 may support at least one of communication schemes based on various communication standards such as LTE, global system for mobile communications (GSM), or code-division multiple access (CDMA), but is not limited thereto.

The terrestrial network and the non-terrestrial network may be networks independent of each other. Alternatively, the terrestrial network and the non-terrestrial network may be included in at least one network (e.g., networks provided by the same operator) associated with each other.

When communication with the terrestrial network is not possible or is not seamless, the electronic device 101 may perform wireless communication through the non-terrestrial network. The electronic device 101 may perform wireless communication through the non-terrestrial network regardless of the communication state with the terrestrial network.

According to an embodiment, the electronic device 101 may include a processor (e.g., including processing circuitry) 120, a display module 160 (e.g., including a display), a wireless communication module 192 (e.g., including a communication circuit), and/or an antenna module (e.g., including at least one antenna) 197. For example, the processor 120 may be operatively, functionally, and/or electrically connected to the display module 160, the wireless communication module 192, and/or the antenna module 197.

The processor 120 may include various processing circuitry and execute, e.g., instructions (e.g., the program 140 of FIG. 1A) at least temporarily stored in memory (e.g., the memory 130 of FIG. 1A) to control at least one other component (e.g., a hardware or software component) of the electronic device 101 connected to the processor 120, and may perform various data processing or computation. According to an embodiment, the processor 120 may control overall operations related to terrestrial network communication and/or non-terrestrial network communication. For example, the processor 120 may include a communication processor (e.g., the auxiliary processor 123 of FIG. 1A) related to terrestrial network communication and/or non-terrestrial network communication. The detailed description of processor 120 in FIG. 1A is incorporated here and the detailed description may not be repeated.

The display module 160 may include at least one display and visually provide information to the outside (e.g., a user) of the electronic device 101.

According to an embodiment, the display module 160 may display a user interface (UI) indicating information related to a terrestrial network and/or a non-terrestrial network. For example, the UI indicating information related to the terrestrial network and/or the non-terrestrial network may include at least one of UIs indicating information related to the type of network (e.g., cellular communication (3G, 4G, or 5G), short-range communication (e.g., BT, or WI-FI), or satellite communication), the type of network service provider (e.g., satellite communication service provider (Iridium), emergency service provider (ESP)), the strength of the network signal (e.g., signal strength bars, RSSI, or RSRP)), the direction of the communication device (satellite) included in the network (e.g., the orientation, the elevation angle, or the azimuth angle), presence information, and/or the network communication state (e.g., idle, transmit, or receive).

According to an embodiment, the display module 160 may display a UI indicating the service related to the terrestrial network and/or the non-terrestrial network.

According to an embodiment, the service related to the terrestrial network and/or the non-terrestrial network may include at least one of, e.g., an emergency message transmission service, a messaging service, a voice call, a video call, a data communication service, a location-related service, and/or a service related to an indicator.

According to an embodiment, the emergency message transmission service may include, but is not limited to, at least one of an SOS service state information providing service (e.g., display whether it is possible to provide an SOS service), a government office information providing service, an emergency contact information providing service, a text template providing service that minimizes/reduces the user's text entry, or a questionnaires service (e.g., a service for providing questionnaires, such as accident type, injured area, or medical information (e.g., age, gender, disease information, or medication information)) for quickly letting the emergency situation know.

According to an embodiment, the messaging service may include at least one of a short message service (SMS), a multimedia messaging service (MMS), or a rich communication suite (RCS) message, but is not limited thereto.

According to an embodiment, the data communication service may include a service through various applications (e.g., web browsers) that provide data communication.

According to an embodiment, the location-related service may include, but is not limited to, at least one of longitude/latitude coordinates, location-related map information about the non-terrestrial communication device 220, navigation, or a street view.

According to an embodiment, the UI example is not limited to the above-mentioned example, and may be provided through another output device (e.g., the sound output module 155 of FIG. 1A).

According to an embodiment, the wireless communication module 192 may include various circuitry and support various types of wireless communication bands supported by the electronic device 101. For example, the wireless communication band supported by the electronic device 101 may include a short-range wireless communication band (e.g., BT or Wi-Fi), a terrestrial network (e.g., cellular network) communication band, and/or a non-terrestrial network band, but is not limited thereto.

According to an embodiment, the electronic device 101 may support a frequency band (e.g., n255, or n256) related to non-terrestrial network wireless communication. The electronic device 101 may perform non-terrestrial network wireless communication using a frequency band related to non-terrestrial network wireless communication, but is not limited thereto. For example, the electronic device 101 may perform non-terrestrial network wireless communication using at least a portion of the frequency band related to terrestrial network wireless communication.

According to an embodiment, the antenna module 197 may include at least one antenna and transmit and/or receive a signal or power to or from the outside (e.g., the external electronic device).

According to an embodiment, the electronic device 101 may perform wireless communication with the non-terrestrial network using at least one antenna among the plurality of antennas included in the antenna module 197. At least one antenna supporting non-terrestrial wireless communication may include a dedicated antenna and/or a multi-use antenna. The dedicated antenna may include an antenna supporting the non-terrestrial network. The multi-use antenna may include an antenna that supports different types of networks and non-terrestrial networks together. For example, the electronic device 101 may communicate with at least one satellite (e.g., a GNSS satellite or a satellite for emergency message service) using at least one non-terrestrial network-dedicated antenna. For example, the multi-use antenna may include an antenna supporting a short-range communication network (e.g., a Bluetooth network or a Wi-Fi network) and/or a terrestrial network (e.g., a long term evolution (LTE) network). The electronic device 101 may support a non-terrestrial network using a plurality of antennas among antennas supporting the terrestrial network.

In the disclosure, a satellite is mainly mentioned as the non-terrestrial wireless communication device 220, and even if it is mentioned that the satellite provides wireless communication using a specific radio access technology (RAT) (e.g., LTE) or a specific function (e.g., a base station), this is merely an example, and the type thereof is not limited.

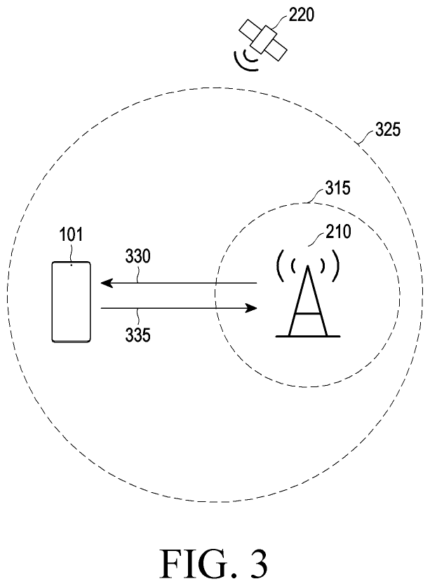

FIG. 3 is a diagram illustrating example access to an electronic device according to various embodiments.

According to an embodiment, the electronic device 101 may be positioned within the coverage 315 (hereinafter, referred to as the terrestrial wireless communication coverage 315) of the terrestrial wireless communication device 210 and/or the coverage 325 (hereinafter, referred to as the non-terrestrial wireless communication coverage 325) of the non-terrestrial wireless communication device 220. The non-terrestrial wireless communication coverage 325 may be relatively larger (e.g., 50 times larger) than the terrestrial wireless communication coverage 315. For example, the non-terrestrial wireless communication coverage 325 may cover an area not covered by the coverage 315 of the terrestrial wireless communication device 210, and accordingly, the electronic device 101 may perform communication even in an area where terrestrial wireless communication is not supported.

According to an embodiment, the electronic device 101 may perform a cell scan within the terrestrial wireless communication coverage 315 and/or the non-terrestrial wireless communication coverage 325. As a result of performing the cell scan, the electronic device 101 may identify a cell provided by the terrestrial wireless communication device 210 and/or a cell provided by the non-terrestrial wireless communication device 220. When there is a cell that meets the cell selection criteria, the electronic device 101 may perform at least some of operations for connecting to a network (e.g., a non-terrestrial network and/or a terrestrial network). Here, the connection to the network may include, e.g., at least some of a preceding operation (e.g., camp-on, or connection procedure (e.g., random connection (RA) procedure)) for registration to the network and/or a registration operation (e.g., attach, or registration)) to the network, but is not limited thereto. When disconnection from the network is required (e.g., moving to another network), the electronic device 101 may perform at least some of the disconnect operations. The operation for disconnecting from the network may include at least some of a detach, release of connection, and/or radio link failure (RLF) declaration from the network, and is not limited to the listed operations.

According to an embodiment, the electronic device 101 may perform at least some of cell scan, disconnection from the network, and/or connection to the network according to movement 330 or 335.

According to an embodiment, when the electronic device 101 is positioned within the terrestrial communication coverage 315 included in the non-terrestrial wireless communication coverage 325 or is positioned in the boundary area of the terrestrial communication coverage 315, the electronic device 101 may connect to the terrestrial network and/or the non-terrestrial network based on the policy (e.g., priority policy) of the electronic device 101.

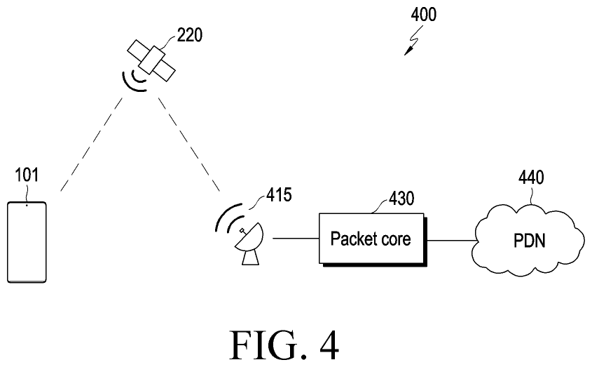

FIG. 4 is a diagram illustrating an example non-terrestrial network system 400 according to various embodiments.

Referring to FIG. 4, a non-terrestrial network system 400 may include a non-terrestrial wireless communication device 220, a radio unit 415, a packet core 430, and/or a packet data network (PDN) 440.

According to an embodiment, the non-terrestrial network system 400 may be implemented, e.g., in a regenerative manner. When implemented in a regenerative manner, the at least one non-terrestrial wireless communication device 220 may include a base station (e.g., eNode B). The non-terrestrial network system 400 may be implemented, e.g., in a bent-pipe manner. The bent-pipe manner may include a passive relay manner that performs frequency conversion and power amplification on the received signal. When the non-terrestrial network system 400 is implemented in a bent-pipe manner, the at least one non-terrestrial wireless communication device 220 may include a relay that converts (e.g., amplifies) and transmits a signal. The implementation method of the non-terrestrial network system 400 and the role of the non-terrestrial wireless communication device 220 described in FIG. 4 are merely examples, and are not limited thereto.

According to an embodiment, the non-terrestrial wireless communication device 220 may include at least one satellite. The non-terrestrial wireless communication device 220 may communicate with, e.g., the electronic device 101 using a terrestrial network (e.g., a cellular network) band and/or a non-terrestrial network band. The terrestrial network band may be, e.g., an operating band supported by long term evolution (LTE) and/or new radio (NR), but is not limited thereto. The non-terrestrial network band may include a band (e.g., n255 and/or n256 bands) defined by 3GPP, but is not limited thereto.

According to an embodiment, the at least one radio unit 415 may receive a signal of the non-terrestrial wireless communication device 220 and transmit the signal to the packet core 430. The radio unit 415 and the non-terrestrial wireless communication device 220 may perform communication using, e.g., a non-terrestrial network band. The non-terrestrial network band may be different from the terrestrial network band, but may be set to be the same in some cases.

According to an embodiment, the at least one packet core 430 may transmit and receive data associated with the electronic device 101 using the radio unit 415. Accordingly, the packet core 430 may process the data associated with the electronic device 101 and transmit the processed data to a packet data network (PDN) 440 (e.g., the Internet). The packet core 415 may include, e.g., at least some of an evolved packet core (EPC) and/or a 5G core (5GC), but is not limited thereto. The packet core 430 may include a packet core associated with the operator of the non-terrestrial wireless communication device 220 and/or a packet core associated with the mobile network operator (MNO). The packet core 430 may be additionally connected to a public switched telephone network (PSTN) (not shown) to transmit and receive data associated with the electronic device 101.

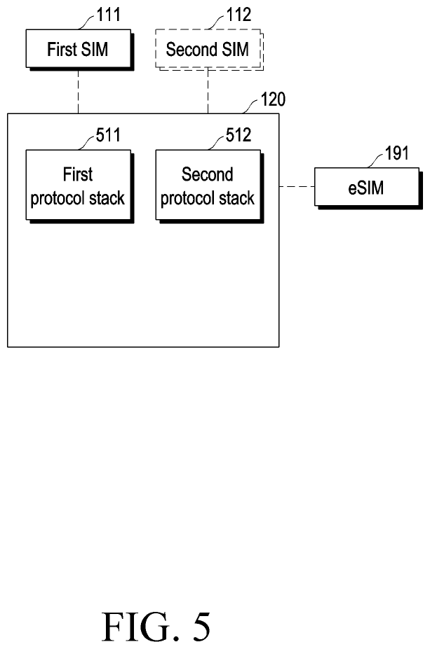

FIG. 5 is a block diagram illustrating an example configuration of an electronic device according to various embodiments.

According to an embodiment, the electronic device 101 (e.g., the processor 120) may execute (or include) a first protocol stack 511 and a second protocol stack 512. The protocol stacks 511 and 512 may include, e.g., a set of instructions (or code, or modules) for each layer, but the disclosure is not limited thereto. In FIG. 5, the protocol stacks 511 and 512 are illustrated as being included in the processor 120, but this is merely an example and may refer to the processor 120 (e.g., a communication processor) performing at least one instruction using the protocol stacks 511 and 512, but the disclosure is not limited thereto. The protocol stacks 511 and 512 may include at least one instruction (or code) corresponding to, e.g., a physical layer, an L1 layer, an L2 layer, a radio resource control (RRC) layer, a public land mobile network (PLMN) searching layer (or may be referred to as a PLMN searching module), and/or an evolved mobility management (EMM)/new radio (NR) mobility management (MM) layer, but the disclosure is not limited thereto.

For example, the electronic device 101 may perform a first communication using the first SIM 111 and the first protocol stack 511. If a second SIM 112 is connected to the electronic device 101, the electronic device 101 may perform a second communication using information associated with the second SIM 112 and the second protocol stack 512. If the second SIM 112 is not connected to the electronic device 101 and in general cases, the electronic device 101 may be configured to refrain from performing operations associated with the second protocol stack 512. However, even when the second SIM 112 is not connected to the electronic device 101, the electronic device 101 may perform operations using the second protocol stack 512 based on the occurrence of a designated trigger. For example, based on the first SIM 111 and the first protocol stack 511, the electronic device 101 may perform operations using the second protocol stack 512 by being triggered by access of the electronic device 101 to the cell of the NTN. The cell of the NTN may not support emergency services (e.g., reception of emergency messages and/or emergency calls) in some cases, and thus the electronic device 101 may be configured to perform operations using the second protocol stack 512 by being triggered by access of the electronic device 101 to the cell of the NTN. As is described below, the electronic device 101 may perform a limited camp-on to a cell that is not a suitable cell using the second protocol stack 512 (this may be referred to as camp-on based on any cell selection). Since the electronic device 101 has performed a limited camp-on without information about the SIM, it may not perform normal data transmission/reception but may perform emergency services (e.g., reception of emergency messages and/or emergency calls). Accordingly, the electronic device 101 may perform emergency services through a limited camp-on cell based on the second protocol stack 512, in cases where the cell of the NTN based on the first protocol stack 511 does not support emergency services (e.g., reception of emergency messages and/or emergency calls).

The information associated with the first SIM 111 and/or the second SIM 112 may be replaced with information stored in the eSIM 191 (e.g., a profile activated based on the eSIM 191, but not limited thereto), but is not limited thereto. For example, the electronic device 101 may be in a state in which only the first SIM 111 is connected and the second SIM 112 is not connected, or only the first SIM 111 is connected and no additional profile is activated by the eSIM 191, or only one profile is activated by the eSIM 191, which is described below.

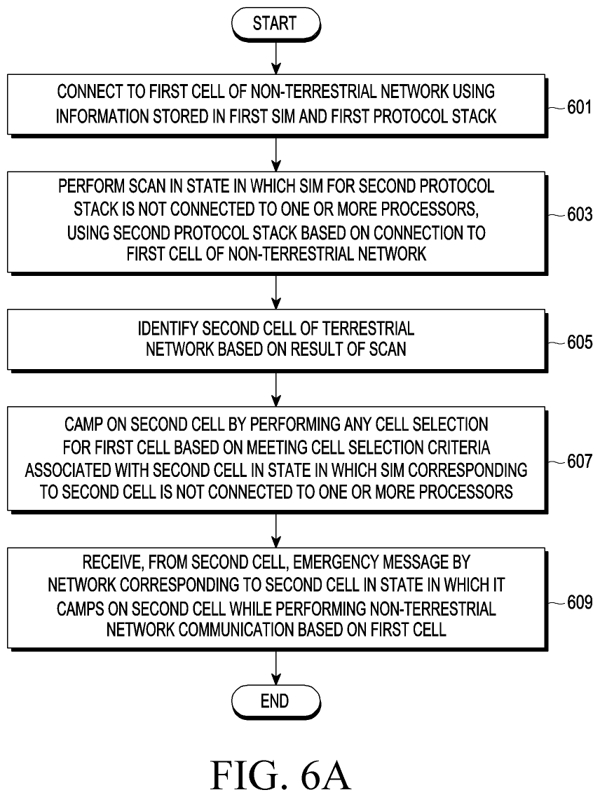

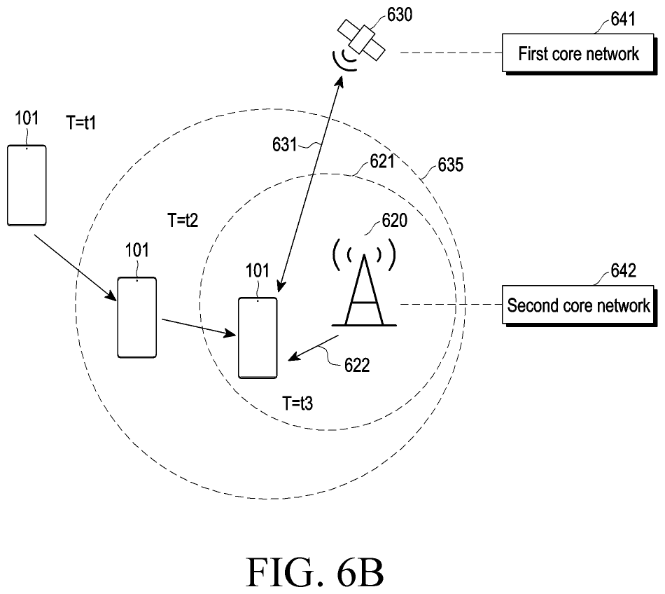

FIG. 6A is a flowchart illustrating an example method of operating an electronic device according to various embodiments. FIG. 6A is described with reference to FIG. 6B. FIG. 6B is a diagram illustrating an example cell of a non-terrestrial network and an example cell of a terrestrial network according to various embodiments.

According to an embodiment, in operation 601, the electronic device 101 may connect to a first cell 630 of a non-terrestrial network, where the electronic device 101 may be registered, as illustrated in FIG. 6B, using the first protocol stack 511 among protocol stacks for the plurality of SIMs and the information stored in the first SIM 111 in a state in which the first SIM 111 is connected to the processor 120. For example, the first SIM 111 may store information corresponding to the network associated with the first cell 630. For example, according to a time flow from a first time t1 to a second time t2, the electronic device 101 may move into the coverage 635 of the first cell 630 of the non-terrestrial network. The electronic device 101 may identify the first cell 630 of the non-terrestrial network based on a scan result. The electronic device 101 may camp on the first cell 630 based on the first cell 630 meeting cell selection criteria and being a suitable cell. The electronic device 101 may establish an RRC connection based on the first cell 630. The electronic device 101 may perform a registration (or attach) procedure to a first core network 641 corresponding to the first cell 630 based on the first cell 630. Prior to connection to the first cell 630 of the non-terrestrial network, operations associated with the remaining protocol stacks, except for the first protocol stack among the protocol stacks, may be deactivated based on the non-identification of SIM connection associated with the remaining protocol stacks. For example, the electronic device 101 may deactivate operations associated with the protocol stack corresponding to another slot when the first SIM 111 is connected and no separate SIM is connected to the other slot.

The provision of emergency messages based on the first cell 630 of the non-terrestrial network may not be supported. For example, the provision of a commercial mobile alert system (CMAS) message and/or an earthquake and tsunami warning system (ETWS) message based on the first cell 630 of the non-terrestrial network may not be supported. For example, in the technical specification (TS) 36.331 of 3rd generation project partnership (3GPP), it is disclosed that a CMAS message and/or an ETWS message may be broadcast based on system information block (SIB) 8. In TS 36.331, it is disclosed that when SIB 8 includes an alert message (CMAS message and/or ETWS message) and complete geographical area coordinates, the information of the alert message should be transmitted to an upper layer. However, the complete geographical area coordinates may not be set for the first cell 630 of the non-terrestrial network, and it may be impossible to receive an emergency message based on the first cell 630 of the non-terrestrial network. Alternatively, for example, in the technical specification (TS) 36.331 of 3rd generation partnership project (3GPP), it is disclosed that the RRC protocol may broadcast system information. Here, it is disclosed that the broadcast system information may include ETWS notifications and CMAS notifications, but it is disclosed that ETWS notifications and CMAS notifications are not applicable to narrowband Internet of things (NB-IoT). When the first cell 630 of the non-terrestrial network is based on NB-IoT, the provision of emergency messages may not be supported. As described above, the reception of emergency messages based on the first cell 630 of the non-terrestrial network may not be supported, which may be a critical issue related to user safety.

The electronic device 101, in operation 603, may perform a scan using a second protocol stack 512 different from the first protocol stack among a plurality of protocol stacks based on a connection to the first cell 630 of the non-terrestrial network, in a state in which the SIM for the second protocol stack 512 is not connected to the one or more processors 120. As described above, the reception of emergency messages may not be supported while connected to the first cell 630 of the non-terrestrial network. Accordingly, the electronic device 101 may perform a scan using the second protocol stack 512 even though an additional SIM is not connected (or an additional profile is not activated). For example, when the electronic device 101 is connected to a terrestrial network cell based on the first protocol stack 511, the electronic device 101 may refrain from performing operations associated with the second protocol stack 512 if the SIM is not connected. However, since the reception of emergency messages may not be supported while connected to the first cell 630 of the non-terrestrial network, the electronic device 101 may perform a scan using the second protocol stack 512 even though an additional SIM is not connected (or an additional profile is not activated).

The electronic device 101, in operation 605, may identify a second cell 620 of the terrestrial network based on the result of the scan, as illustrated in FIG. 6B. For example, at a third time t3, the electronic device 101 may be positioned in the coverage 621 of the second cell 620 of the terrestrial network. The electronic device 101 may identify the second cell 620 based on the result of the scan. The electronic device 101, in operation 607, may camp on the second cell by performing any cell selection for the second cell 620 based on meeting cell selection criteria associated with the second cell 620 in a state in which a SIM corresponding to the second cell 620 is not connected to the one or more processors 120. For example, it may be identified that the reception strength (which may be reference signal received power (RSRP) and/or reference signal received quality (RSRQ) but is not limited thereto) from the second cell 620 meets the cell selection criteria. In order for the second cell 620 to be a suitable cell, the PLMN of the second cell 620 should be a PLMN selected by non-access stratum (NAS) or a registered PLMN. However, as described above, since the electronic device 101 uses the second protocol stack 512 in a state in which the SIM is not connected, the PLMN of the second cell 620 is neither a PLMN selected by NAS nor a registered PLMN. Accordingly, from the perspective of the electronic device 101, the second cell 620 of the second PLMN may be an acceptable cell rather than a suitable cell. An acceptable cell may be a cell that does not meet the conditions to be a suitable cell but meets a minimum conditions. The minimum conditions may include the cell not being barred and the cell selection criteria being met. The electronic device 101, according to 3GPP TS 36.304, may perform any cell selection due to the non-identification of a suitable cell, thereby camping on the acceptable cell, which is the second cell 620. The camp-on resulting from any cell selection for an acceptable cell may be referred to as limited camp-on for convenience of description.

The electronic device 101, in operation 609, may perform non-terrestrial network communication 631 based on the first cell 630 of the non-terrestrial network, while in a camped-on state on the second cell 620, receiving an emergency message 622 from the second cell 620 by the network corresponding to the second cell 620 (e.g., the second core network 642, but not limited thereto). When limited camp-on is performed, the electronic device 101 may not perform general communication through the second cell 620, but may perform reception of an emergency service which is an emergency message. Accordingly, as described above, even when the first cell 630 of the non-terrestrial network does not support emergency messages, the electronic device 101 may receive an emergency message through the limited camp-on second cell 620.

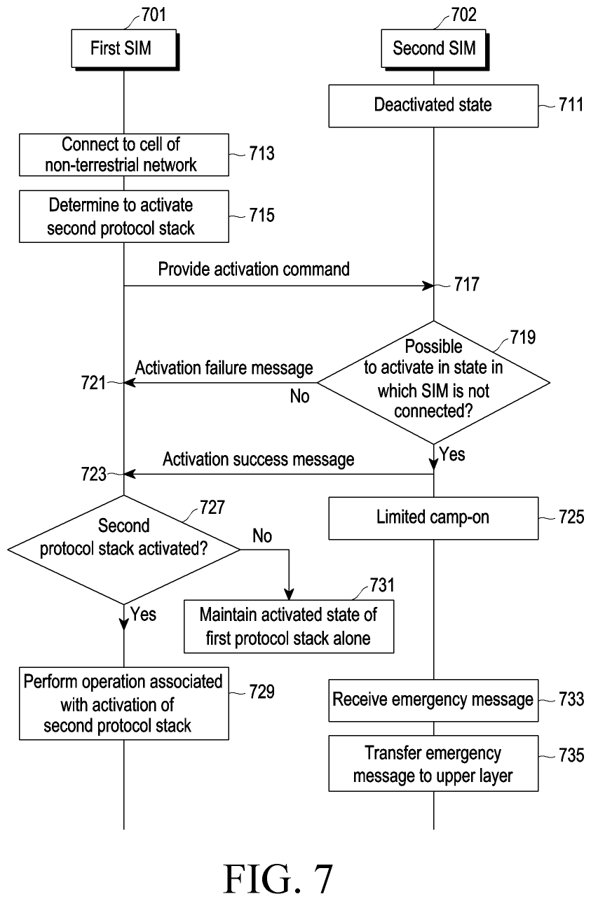

FIG. 7 is a signal flow diagram illustrating an example method of operating an electronic device according to various embodiments.

According to an embodiment, the electronic device 101 may execute (or include) a first SIM module 701 and/or a second SIM module 702. The SIM modules 701, 702 may be entities that control to activate or deactivate operations associated with a corresponding protocol stack (e.g., the protocol stack 511, 512) according to whether the SIM (e.g., the SIMS 111, 112) is connected (or whether the profile is activated), but the disclosure is not limited thereto. For example, the first SIM module 701 corresponding to the first protocol stack 511 associated with a default data SIM (DDS) may perform operations based on the first protocol stack 511 even in a state in which the SIM is not connected. The second SIM module 702 corresponding to the second protocol stack 512 associated with non-DDS may refrain from performing operations based on the second protocol stack 512 in a state in which the SIM is not connected (e.g., in a state connected to the terrestrial network cell based on the first protocol stack 511) to save power.

Based on the first SIM module 701, e.g., in a state connected to the terrestrial network cell, the second SIM module 702 may be in an inactive state in operation 711. Accordingly, the performance of operations based on the second protocol stack 512 may be refrained from. The first SIM module 701 may perform a connection to the non-terrestrial network cell in operation 713. The first SIM module 701 may determine to activate the second protocol stack 512 in operation 715. As described above, since the non-terrestrial network cell may not support emergency messages, the first SIM module 701 may determine to activate the second protocol stack 512 by being triggered by the connection to the non-terrestrial network cell. The first SIM module 701 may provide an activation command to a second SIM module 702 in operation 717. The second SIM module 702 may determine whether activation is possible in a state in which the SIM is not connected or the profile is not activated in operation 719. When activation is not possible (operation 719-No), the second SIM module 702 may provide an activation failure message to the first SIM module 701 in operation 721. When activation is possible (operation 719-Yes), the second SIM module 702 may provide an activation success message to the first SIM module 701 in operation 723. The second SIM module 702 may perform a limited camp-on using the second protocol stack 512 in operation 725. The first SIM module 701 may determine whether the second protocol stack 512 is activated in operation 727. When the second protocol stack 512 is activated (operation 727-Yes), the first SIM module 701 may perform operations associated with the activation of the second protocol stack 512 in operation 729. For example, the first SIM module 701 may monitor whether it is connected to the terrestrial network cell based on the first protocol stack 511 and, based on identifying the connection to the terrestrial network cell, may provide a deactivation command for the second SIM 702, but the disclosure is not limited thereto. When the second protocol stack 512 is not activated (operation 727-No), the first SIM module 701 may maintain the activation of the first protocol stack alone in operation 731. The second SIM module 702 may receive an emergency message through the cell where the limited camp-on was performed in operation 733. The second SIM module 702 may provide the received emergency message to an upper layer in operation 735.

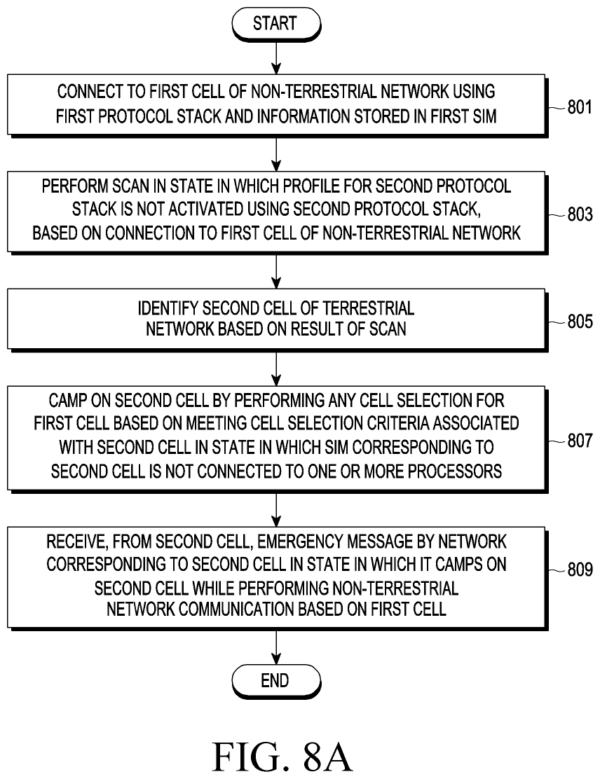

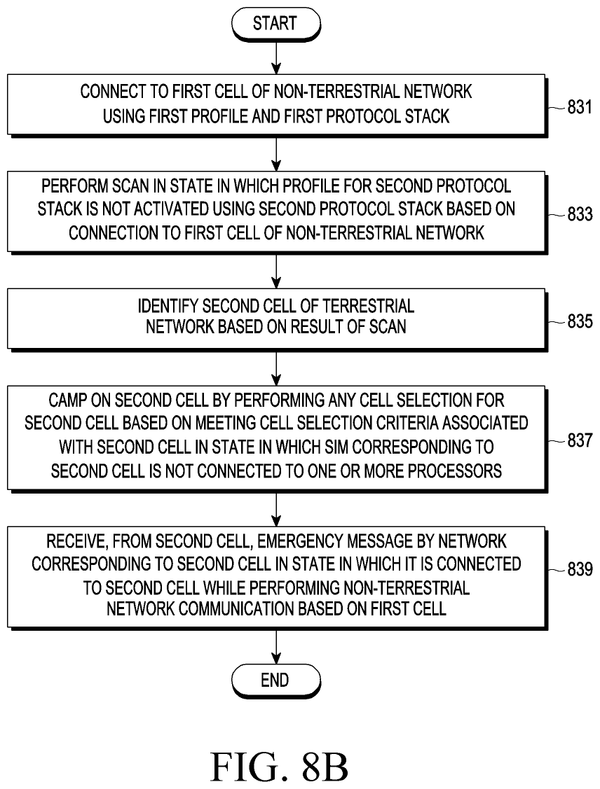

FIG. 8A is a flowchart illustrating an example method of operating an electronic device according to various embodiments.

According to an embodiment, the electronic device 101 may connect to the first cell 630 of the non-terrestrial network in operation 801, using the first protocol stack 511 among the protocol stacks for the plurality of SIMs, in a state in which the first SIM 111 is connected to the processor 120 and using information stored in the first SIM 111. For example, it is assumed that the first SIM 111 corresponding to the first protocol stack 511 is connected to the processor 120, and the profile is not activated by the eSIM 191. In operation 803, the electronic device 101 may perform a scan using the second protocol stack 512, which is different from the first protocol stack, among the plurality of protocol stacks, based on the connection to the first cell 630 of the non-terrestrial network, in a state in which the profile for the second protocol stack 512 is not activated. The electronic device 101 may identify the second (e.g., terrestrial) cell 620 based on the result of the scan in operation 805. In operation 807, the electronic device 101 may camp on the second cell by performing any cell selection for the second cell 620 based on meeting the cell selection criteria associated with the second cell 620 in a state in which the SIM corresponding to the network of the second cell 620 is not connected to the one or more processors 120 (or the profile corresponding to the network of the second cell 620 is not activated). The electronic device 101, in operation 809, may perform non-terrestrial network communication 631 based on the first cell 630 of the non-terrestrial network, while in a camped-on state on the second cell 620, receiving an emergency message 622 from the second cell 620 by the network corresponding to the second cell 620 (e.g., the second core network 642, but not limited thereto).

FIG. 8B is a flowchart illustrating an example method of operating an electronic device according to various embodiments.

According to an embodiment, the electronic device 101 may connect to a first cell 630 in operation 831, using the first profile corresponding to the first protocol stack 511 and the first protocol stack 511. For example, it is assumed that only the profile for the first protocol stack 511 is activated by the eSIM 191, in a state in which an rSIM is not connected to the processor 120 (or a state in which the electronic device 101 does not include a slot for inserting the rSIM). In operation 833, the electronic device 101 may perform a scan in a state in which the profile for the second protocol stack 512 is not activated using the second protocol stack 512 different from the first protocol stack 511 among the plurality of protocol stacks based on the connection to the first cell 630 of the non-terrestrial network. The electronic device 101 may identify the second cell 620 of the terrestrial network based on the result of the scan in operation 835. In operation 837, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the network of the second cell 620 is not activated). The electronic device 101, in operation 839, may perform non-terrestrial network communication 631 based on the first cell 630 of the non-terrestrial network, while in a camped-on state on the second cell 620, receiving an emergency message 622 from the second cell 620 by the network corresponding to the second cell 620 (e.g., the second core network 642, but not limited thereto).

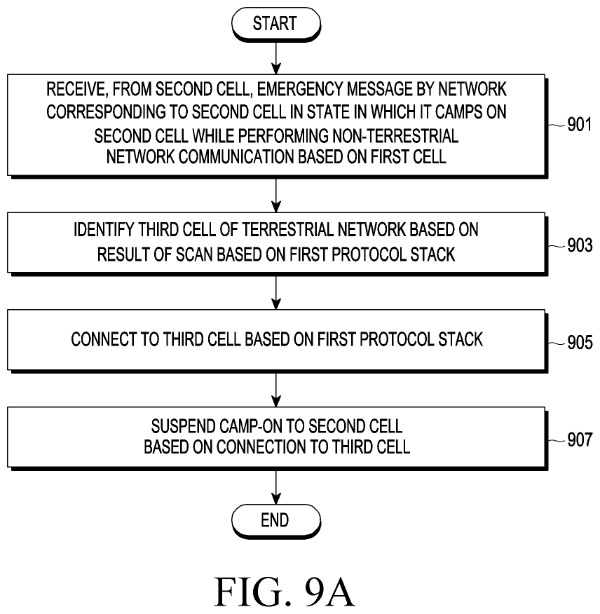

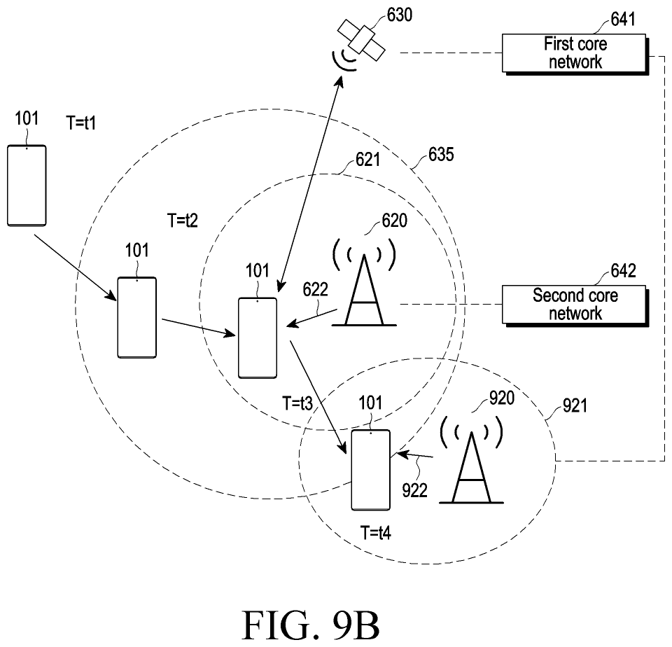

FIG. 9A is a flowchart illustrating an example method of operating an electronic device according to various embodiments. FIG. 9A is described with reference to FIG. 9B. FIG. 9B is a diagram illustrating a cell of a non-terrestrial network and a cell of a terrestrial network according to various embodiments.

According to an embodiment, in operation 901, the electronic device 101 may receive, from the second cell 620, an emergency message 622 by the network (which may be, e.g., the second core network 642, but is not limited) corresponding to the second cell 620 in a state in which it camps on the second cell 620 while performing non-terrestrial network communication based on the first cell 630 of the non-terrestrial network, e.g., as at a third time t3 of FIG. 9B. The arrangement and/or operation of the electronic device 101 associated with the first time t1, the second time t2, and the third time t3 has been described with reference to FIGS. 6A and 6B, and thus the description thereof will not be repeated here. The electronic device 101 may identify a third cell 920 of the terrestrial network in which the electronic device 101 may be registered based on the result of the scan based on the first protocol stack 511 in operation 903, as at a fourth time t4 of FIG. 9B. For example, at the fourth time t4, the electronic device 101 may be positioned in the coverage 921 of the third cell 920, and accordingly, the electronic device 101 may identify the third cell 920. The third cell 920 may be identified based on a cell scan or based on a measurement object for handover, but it is understood by those skilled in the art that the identification method is not limited thereto. The electronic device 101 may connect to the third cell 920 based on the first protocol stack 511 in operation 905. For example, the electronic device 101 may connect to the third cell 920 based on a handover procedure from the first cell 630 to the third cell 920, or may release the connection to the first cell 630 and subsequently perform the connection to the third cell 920, but it is understood by those skilled in the art that the connection method is not limited. The electronic device 101 may, in operation 907, suspend camping on the second cell 620 based on the connection to the third cell 920. For example, the electronic device 101 may suspend camping on the second cell 620 by suspending the performance of operations associated with the second protocol stack 512, but there is no limitation on the method of suspension. Since the third cell 920 is the terrestrial network cell, the electronic device 101 may receive an emergency message 922 from a network (e.g., the first core network 641) in which the electronic device 101 may register through the third cell 920. Accordingly, the electronic device 101 may suspend camping on the second cell 620 for power saving. This is merely an example, and the electronic device 101 may maintain camping on the second cell 620.

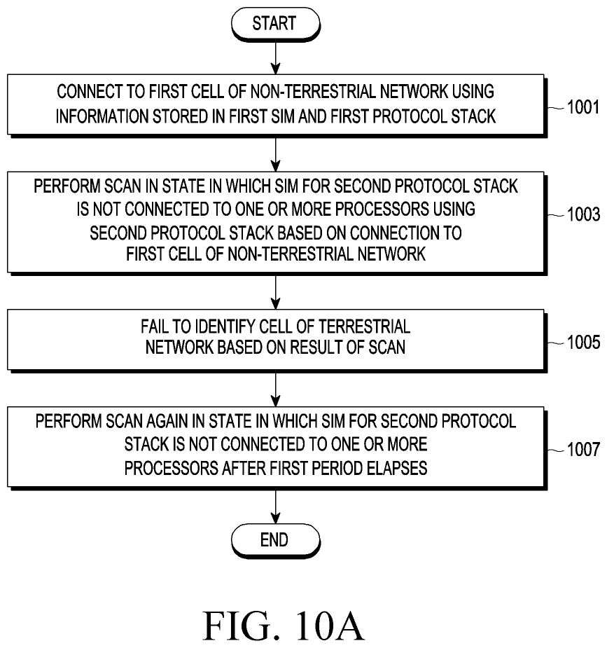

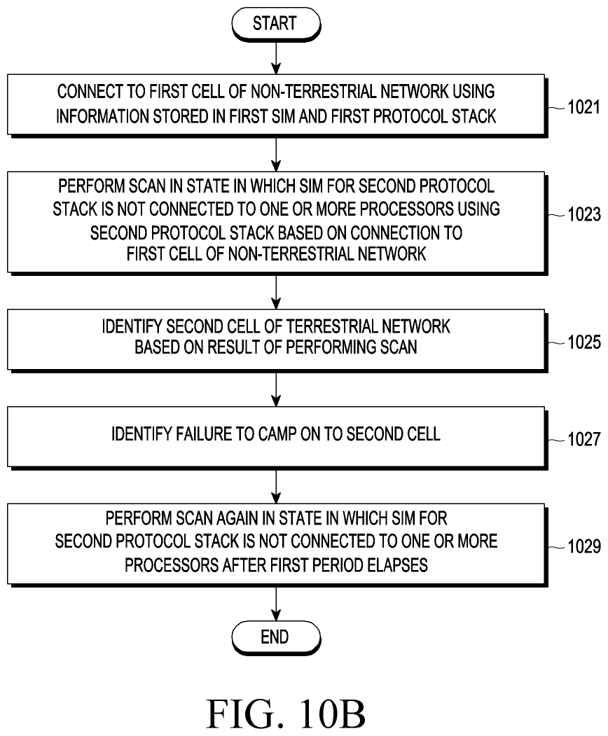

FIG. 10A is a flowchart illustrating an example method of operating an electronic device according to various embodiments.

According to an embodiment, the electronic device 101 may, in operation 1001, connect to the first cell 630 of the non-terrestrial network using the first protocol stack 511 among the protocol stacks for the plurality of SIMs and information stored in the first SIM 111 in a state in which the first SIM 111 is connected to the processor 120. In operation 1003, based on the connection to the first cell 630 of the non-terrestrial network, the electronic device 101 may perform a scan using the second protocol stack 512 different from the first protocol stack among the plurality of protocol stacks in a state in which the profile for the second protocol stack 512 is not activated. The electronic device 101 may, in operation 1005, fail to identify the terrestrial network cell based on the result of the scan. For example, in FIG. 6B, at the second time t2, since the electronic device 101 is not positioned in the coverage of the terrestrial network cell, the electronic device 101 may perform a scan based on the second protocol stack 512, based on the connection to the cell of the NTN 630 but may fail to identify the terrestrial network cell based on the scan. In operation 1007, the electronic device 101 may perform the scan again after a first period (e.g., 10 minutes) elapses in a state in which the SIM for the second protocol stack 512 is not connected to one or more processors. Here, the first period may be longer than, e.g., the cell scan period. For example, when the electronic device 101 is implemented as a small device such as a wearable electronic device, the battery capacity may be relatively small, so that the scan may be performed according to a relatively long first period for power saving. For example, the electronic device 101 may perform the scan according to a relatively long first period for power saving when the state of charge (SOC) is identified to be in a low power state, and there is no limitation on the conditions for a scan based on the relatively long first period.

FIG. 10B is a flowchart illustrating an example method of operating an electronic device according to various embodiments.

According to an embodiment, the electronic device 101 may, in operation 1021, connect to the first cell 630 of the non-terrestrial network using the first protocol stack 511 among the protocol stacks for the plurality of SIMs and information stored in the first SIM 111 in a state in which the first SIM 111 is connected to the processor 120. In operation 1023, based on the connection to the first cell 630 of the non-terrestrial network, the electronic device 101 may perform a scan using the second protocol stack 512 different from the first protocol stack among the plurality of protocol stacks in a state in which the profile for the second protocol stack 512 is not activated. The electronic device 101 may, in operation 1025, identify the second cell of the terrestrial network based on the result of the scan. In operation 1027, the electronic device 101 may identify a failure to camp on the second cell. For example, the electronic device 101 may identify the failure to camp on the second cell based on identifying that the reception strength corresponding to the second cell does not meet the cell selection criteria or that the second cell is barred, but there is no limitation on the examples of such failure. In operation 1029, the electronic device 101 may perform the scan again after a first period (e.g., 10 minutes) elapses in a state in which the SIM for the second protocol stack 512 is not connected to one or more processors. As described above with reference to FIG. 10A, the first period may be longer than, e.g., the cell scan period.

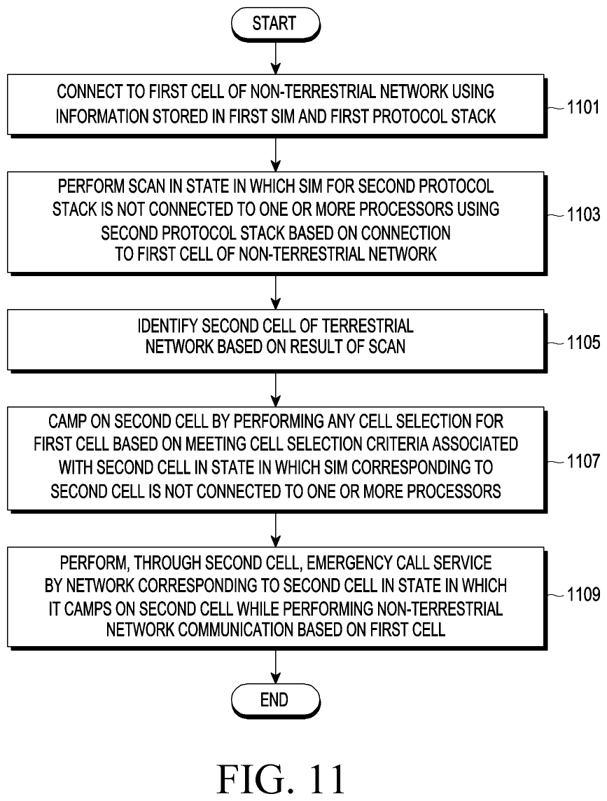

FIG. 11 is a flowchart illustrating an example method of operating an electronic device according to various embodiments.

According to an embodiment, the electronic device 101 may, in operation 1101, connect to the first cell 630 of the non-terrestrial network using the first protocol stack 511 among the protocol stacks for the plurality of SIMs and information stored in the first SIM 111 in a state in which the first SIM 111 is connected to the processor 120. The electronic device 101, in operation 1103, may perform a scan using a second protocol stack 512 different from the first protocol stack among a plurality of protocol stacks based on a connection to the first cell 630 of the non-terrestrial network, in a state in which the SIM for the second protocol stack 512 is not connected to the one or more processors 120. The electronic device 101 may identify the second cell 620 of the terrestrial network based on the result of the scan in operation 1105. In operation 1107, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the second cell 620 is not activated). The electronic device 101, in operation 1109, may perform non-terrestrial network communication 631 based on the first cell 630 of the non-terrestrial network, while in a camped-on state on the second cell 620, performing, through the second cell 620, an emergency call service by the network corresponding to the second cell 620 (e.g., the second core network 642, but not limited thereto). For example, the first cell 630 of the non-terrestrial network may not support the emergency call service. For example, there may be operators that only build services for message transmission but do not build call services for the non-terrestrial network. In this case, the electronic device 101 may perform an emergency call service through the second cell 620 using the second protocol stack 512 instead of the first protocol stack 511 based on identifying a request for an emergency call.

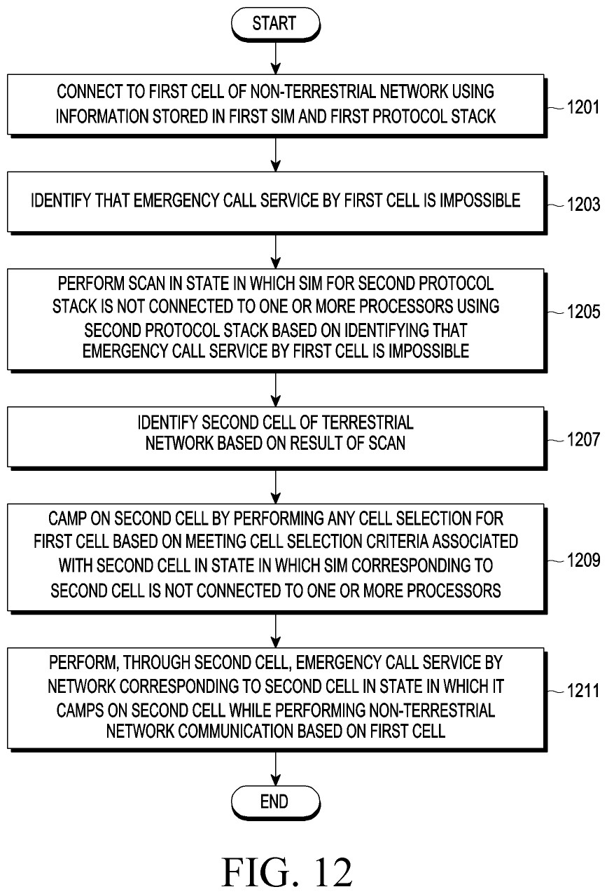

FIG. 12 is a flowchart illustrating an example method of operating an electronic device according to various embodiments.

According to an embodiment, the electronic device 101 may, in operation 1201, connect to the first cell 630 of the non-terrestrial network using the first protocol stack 511 among the protocol stacks for the plurality of SIMs and information stored in the first SIM 111 in a state in which the first SIM 111 is connected to the processor 120. The electronic device 101 may, in operation 1203, identify that an emergency call service may not be performed by the first cell 630 of the non-terrestrial network. For example, during the connection process for the first cell 630 in operation 1201, a registration procedure for the first core network 641 may be performed. During the registration procedure, the electronic device 101 may receive a registration accept message (or an attach accept message) from the first core network 641. The registration accept message may define a system registration result (e.g., a 5GS registration result in case of 5G) field, and information of emergency registered may be included in this field. The information of emergency registered may be information for identifying whether the first core network 641 supports emergency call service, based on which it may be identified that the emergency call service may not be performed by the first cell 630 of the non-terrestrial network. This is an example, and there is no limitation on the method of determining whether the emergency call service by the first cell 630 may be performed. In operation 1205, the electronic device 101 may perform a scan in a state in which the SIM for the second protocol stack 512 is not connected to one or more processors 120 using the second protocol stack 512 different from the first protocol stack among the plurality of protocol stacks based on identifying that it is impossible to perform emergency call service by the first cell 630. The electronic device 101 may, in operation 1207, identify the second cell 620 of the terrestrial network based on the result of the scan. In operation 1209, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the second cell 620 is not activated). The electronic device 101, in operation 1211, may perform non-terrestrial network communication 631 based on the first cell 630 of the non-terrestrial network, while in a camped-on state on the second cell 620, performing, through the second cell 620, an emergency call service by the network corresponding to the second cell 620 (e.g., the second core network 642, but not limited thereto). For example, when the first cell 630 of the non-terrestrial network supports emergency call service, the electronic device 101 may perform an emergency call service based on the first cell 630 and, when the first cell 630 of the non-terrestrial network does not support emergency call service as illustrated in FIG. 12, the electronic device 101 may perform an emergency call service based on the second cell 620.

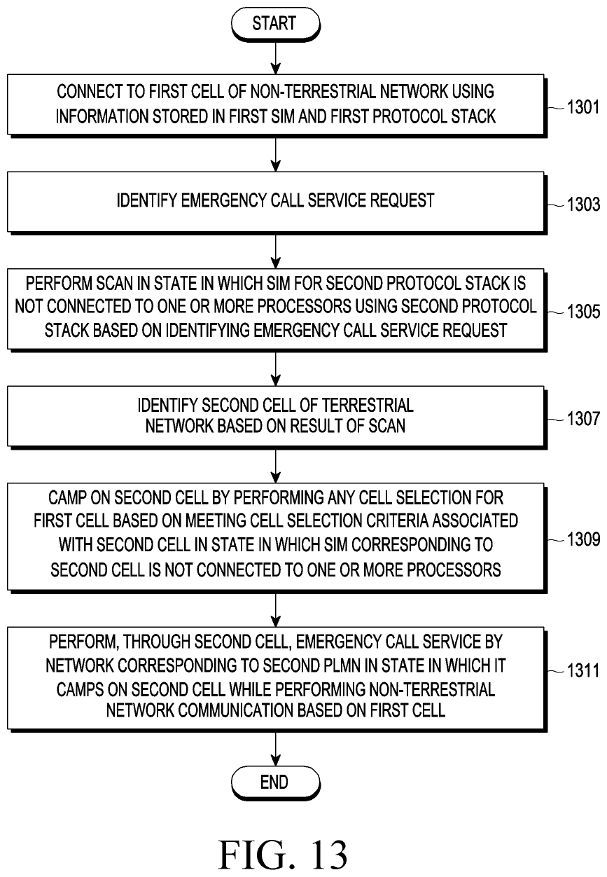

FIG. 13 is a flowchart illustrating an example method of operating an electronic device according to various embodiments.

According to an embodiment, the electronic device 101 may, in operation 1301, connect to the first cell 630 of the non-terrestrial network using the first protocol stack 511 among the protocol stacks for the plurality of SIMs and information stored in the first SIM 111 in a state in which the first SIM 111 is connected to the processor 120. In operation 1303, the electronic device 101 may identify an emergency call service request. For example, the electronic device 101 may identify the emergency call service request according to user manipulation, but the request method is not limited. In operation 1305, the electronic device 101 may perform a scan in a state in which the SIM for the second protocol stack 512 is not connected to one or more processors 120 using the second protocol stack 512 different from the first protocol stack among the plurality of protocol stacks based on identifying the emergency call service request. The electronic device 101 may, in operation 1307, identify the second cell 620 of the terrestrial network based on the result of the scan. In operation 1309, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the second cell 620 is not activated). The electronic device 101, in operation 1311, may perform non-terrestrial network communication 631 based on the first cell 630 of the non-terrestrial network, while in a camped-on state on the second cell 620, performing, through the second cell 620, an emergency call service by the network corresponding to the second cell 620 (e.g., the second core network 642, but not limited thereto). For example, before the emergency call service request is identified, the electronic device 101 may perform communication based on the first cell 630 of the non-terrestrial network and, when the emergency call service request is identified, the electronic device 101 may perform an emergency call service based on the second cell 620 as illustrated in FIG. 13.

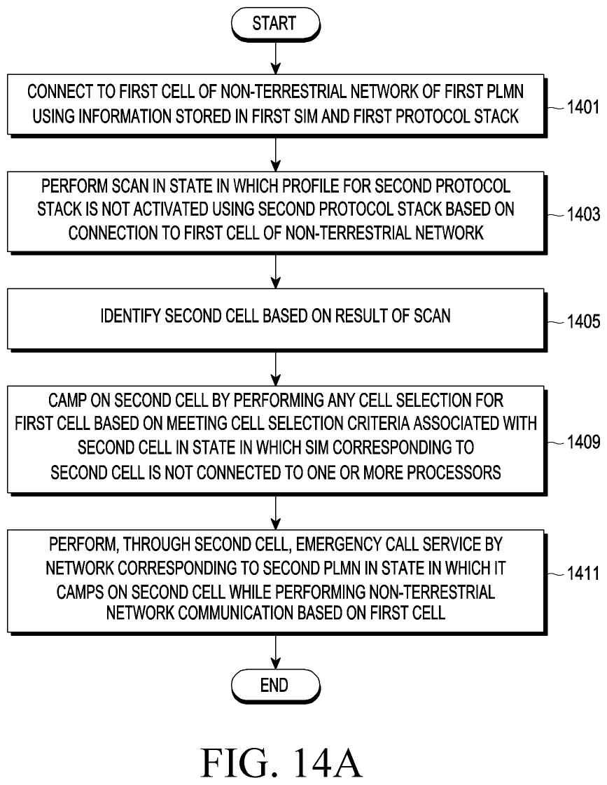

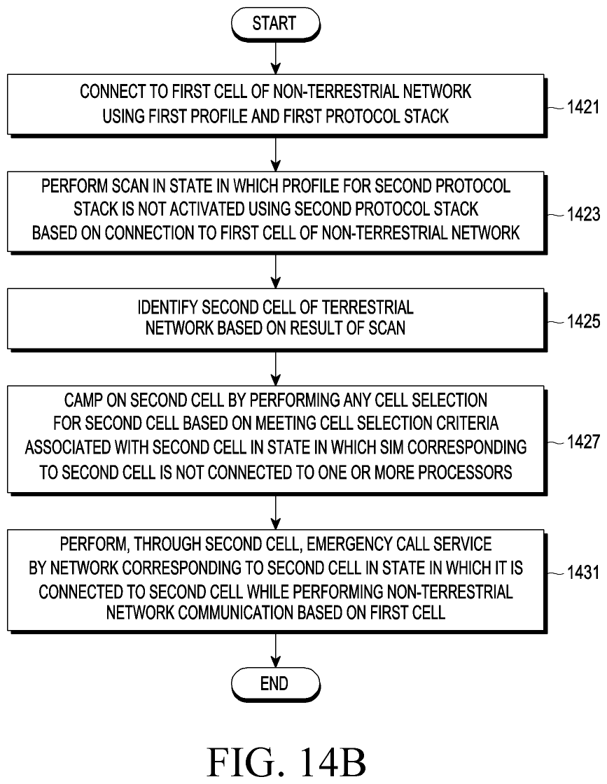

FIG. 14A is a flowchart illustrating an example method of operating an electronic device according to various embodiments.

According to an embodiment, the electronic device 101 may, in operation 1401, connect to the first cell 630 of the non-terrestrial network using the first protocol stack 511 among the protocol stacks for the plurality of SIMs and information stored in the first SIM 111 in a state in which the first SIM 111 is connected to the processor 120. For example, it is assumed that the first SIM 111 corresponding to the first protocol stack 511 is connected to the processor 120, and the profile is not activated by the eSIM 191. In operation 1403, based on the connection to the first cell 630 of the non-terrestrial network, the electronic device 101 may perform a scan using the second protocol stack 512 different from the first protocol stack among the plurality of protocol stacks in a state in which the profile for the second protocol stack 512 is not activated. The electronic device 101 may, in operation 1405, identify the second cell 620 of the terrestrial network based on the result of the scan. In operation 1407, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the second cell 620 is not activated). The electronic device 101, in operation 1409, may perform non-terrestrial network communication 631 based on the first cell 630 of the non-terrestrial network, while in a camped-on state on the second cell 620, performing, through the second cell 620, an emergency call service by the network corresponding to the second cell 620 (e.g., the second core network 642, but not limited thereto).

FIG. 14B is a flowchart illustrating an example method of operating an electronic device according to various embodiments.

According to an embodiment, the electronic device 101 may connect to the first cell 630 of the non-terrestrial network in operation 1421, using the first profile corresponding to the first protocol stack 511 and the first protocol stack 511. For example, it is assumed that only the profile for the first protocol stack 511 is activated by the eSIM 191, in a state in which an rSIM is not connected to the processor 120 (or a state in which the electronic device 101 does not include a slot for inserting the rSIM). In operation 1423, the electronic device 101 may perform a scan in a state in which the profile for the second protocol stack 512 is not activated using the second protocol stack 512 different from the first protocol stack 511 among the plurality of protocol stacks based on the connection to the first cell 630 of the non-terrestrial network. The electronic device 101 may, in operation 1425, identify the second cell 620 of the terrestrial network based on the result of the scan. In operation 1427, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the second cell 620 is not activated). The electronic device 101, in operation 1431, may perform non-terrestrial network communication 631 based on the first cell 630 of the non-terrestrial network, while in a camped-on state on the second cell 620, performing, through the second cell 620, an emergency call service by the network corresponding to the second cell 620 (e.g., the second core network 642, but not limited thereto).

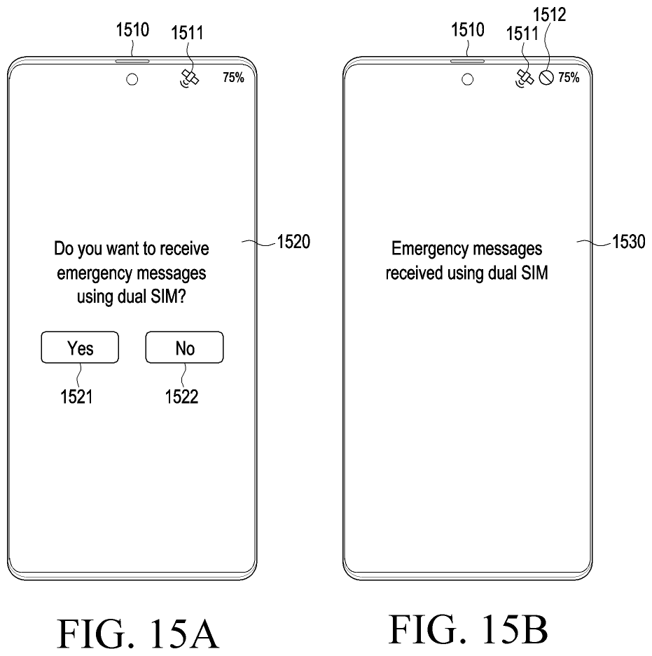

FIGS. 15A and 15B are diagrams illustrating example screens displayed by an electronic device according to various embodiments.

Referring to FIG. 15A, according to an embodiment, the electronic device 101 may display a first screen 1520. On the first screen 1520, a status bar 1510, in which icons representing the state of the electronic device 101 are disposed, may be disposed. For example, as described above, using information stored in a first SIM 111 and the first protocol stack 511, based on connecting to the first cell 630 of the non-terrestrial network, the electronic device 101 may display a visual object 1511, indicating the connection to the cell of the non-terrestrial network, in the status bar 1510. Prior to the connection to the cell of the non-terrestrial network, since operations associated with the second protocol stack 512 are deactivated, the status bar 1510 may include a single visual object 1511, and the display of a visual object associated with the second protocol stack 512 may be refrained from. The first screen 1520 may include text inquiring whether to receive emergency messages using dual SIMs, a visual object 1521 for approval, and/or a visual object 1522 for rejection, but this is merely an example. It is understood by those skilled in the art that a plurality of spaced visual objects 1511, 1512 may be replaced with a visual object such as a toggler. When the visual object 1521 for approval is selected, as described above, the electronic device 101 may perform a limited camp-on to the second cell 620 in a state in which the SIM for the second protocol stack 512 is not connected.

Referring to FIG. 15B, according to an embodiment, the electronic device 101 may display a second screen 1530. The second screen 1530 may include a message indicating the reception of emergency messages using dual SIMs according to user approval, but this is merely an example. The electronic device 101 may perform a limited camp-on to the second cell 620. The electronic device 101 may display, in the status bar 1510, a visual object 1511 indicating the connection to the cell of the non-terrestrial network, along with a visual object 1512 corresponding to a connection failure corresponding to the second protocol stack 512. Since a limited camp-on has been performed for the second cell 620, the visual object 1512 corresponding to the connection failure has been displayed, but it is understood by those skilled in the art that it may be replaced with a visual object indicating an emergency service. As described above, the electronic device 101 may display visual objects 1511, 1512 corresponding to two protocol stacks, even when only a single SIM is connected (or only a single profile is activated). FIGS. 15A and 15B describe settings for the reception of emergency messages, but this is merely an example, and it is understood by those skilled in the art that settings for emergency call services may also be performed through the user interface as illustrated in FIGS. 15A and 15B. For example, the electronic device 101 may be implemented to provide separate user interfaces for the settings of emergency messages and emergency calls, respectively, or to provide a single user interface for the settings of emergency services including both emergency messages and emergency calls.

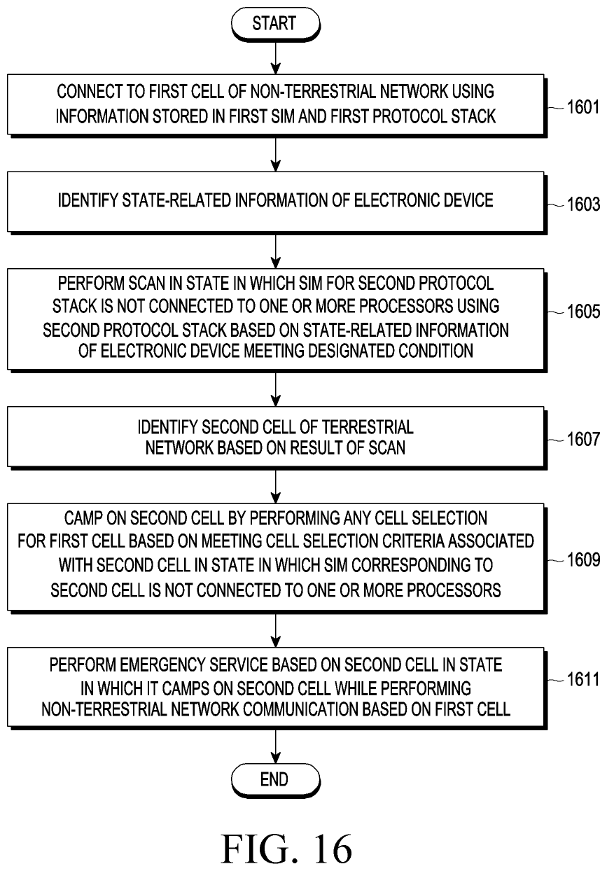

FIG. 16 is a flowchart illustrating an example method of operating an electronic device according to various embodiments.

According to an embodiment, the electronic device 101 may, in operation 1601, connect to the first cell 630 of the non-terrestrial network using the first protocol stack 511 among the protocol stacks for the plurality of SIMs and information stored in the first SIM 111 in a state in which the first SIM 111 is connected to the processor 120. In operation 1603, the electronic device 101 may obtain information related to the state of the electronic device 101. In operation 1605, based on the state-related information of the electronic device 101 meeting designated conditions, the electronic device 101 may perform a scan using the second protocol stack 512 different from the first protocol stack among the plurality of protocol stacks in a state in which the profile for the second protocol stack 512 is not activated. For example, the electronic device 101, in operation 1605, may identify whether the state-related information, including a state of charge (SOC), user settings, and/or an over-temperature state of the electronic device 101, meets designated conditions, but the type of state-related information is not limited. For example, based on the state of charge being above a threshold state of charge, the electronic device 101 may perform a scan using the second protocol stack 512 different from the first protocol stack among the plurality of protocol stacks in a state in which the profile for the second protocol stack 512 is not activated. For example, the electronic device 101 may perform a scan using the second protocol stack 512, which is different from the first protocol stack among the plurality of protocol stacks, in a state in which a profile for the second protocol stack 512 is not activated, when user settings request the performance of emergency messages and/or emergency calls through dual SIMs. For example, the electronic device 101 may perform a scan using the second protocol stack 512, which is different from the first protocol stack among the plurality of protocol stacks, in a state in which a profile for the second protocol stack 512 is not activated, based on identifying that it is not in an over-temperature state.

The electronic device 101 may, in operation 1607, identify the second cell 620 of the terrestrial network based on the result of the scan. In operation 1609, the electronic device 101 may camp on the second cell by performing any cell selection on the second cell 620 based on meeting the cell selection criteria associated with the second cell 620 in a state in which the SIM corresponding to the second cell 620 is not connected to the one or more processors 120 (or a state in which the profile corresponding to the second cell 620 is not activated). The electronic device 101, in operation 1611, may perform non-terrestrial network communication 631 based on the first cell 630 of the non-terrestrial network, while in a camped-on state on the second cell 620, receiving an emergency message 622 from the second cell 620 by the network corresponding to the second cell 620 (e.g., the second core network 642, but not limited thereto).

According to an example embodiment, an electronic device 101 may comprise one or more (e.g., at least one) processors (e.g., including processing circuitry) 120 and memory 130 storing instructions.

At least one processor, comprising processing circuitry, may individually or collectively, be configured to execute the instructions and to cause the electronic device 101 to, in a state in which a first subscriber identity module SIM is connected to the one or more processors 120, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The instructions may, when individually or collectively executed by the one or more processors 120, cause the electronic device 101 to, based on accessing the first cell of the NTN, perform a scan using a second protocol stack different from the first protocol stack among the plurality of protocol stacks, in a state in which a SIM for the second protocol stack is not connected to the one or more processors 120.

The instructions may, when individually or collectively executed by the one or more processors 120, cause the electronic device 101 to, based on a result of the scan, identify a second cell of a terrestrial network (TN).

The instructions may, when individually or collectively executed by the one or more processors 120, cause the electronic device 101 to, based on a cell selection criterion associated with the second cell being satisfied in the state in which the SIM for the second protocol stack is not connected to the one or more processors 120, camp on the second cell by performing any cell selection associated with the second cell.

The instructions may, when individually or collectively executed by the one or more processors 120, cause the electronic device 101 to, in a state in which the electronic device performs NTN communication based on the first cell and camps on the second cell, receive, from the second cell, an emergency message by a network corresponding to the second cell.

The instructions may, when individually or collectively executed by the one or more processors 120, cause the electronic device 101 to, in the state in which the electronic device performs the NTN communication based on the first cell and camps on the second cell, perform an emergency call based on the second cell.

The camp on the second cell may be performed before identification of a request for the emergency call.

The instructions may, when individually or collectively executed by the one or more processors 120, cause the electronic device 101, to, as at least part of performing the scan using the second protocol stack, based on the identification of the request for the emergency call, perform the scan using the second protocol stack.

The instructions may, when individually or collectively executed by the one or more processors 120, cause the electronic device 101, to, as at least part of performing the emergency call based on the second cell, based on identifying that the emergency call is not supported by the first cell of the NTN, perform the emergency call based on the second cell.

The instructions may, when individually or collectively executed by the one or more processors 120, cause the electronic device 101 to, by referring to a network registration accept message based on the first cell, identify whether the emergency call is supported by the first cell of the NTN.

The instructions may, when individually or collectively executed by the one or more processors 120, cause the electronic device 101 to, based on a result of scan based on the first protocol stack, identify a third cell of the TN in which the electronic device 101 is capable of registering, in the state in which the electronic device 101 performs the NTN communication based on the first cell and camps on the second cell.

The instructions may, when individually or collectively executed by the one or more processors 120, cause the electronic device 101 to, based on access to the third cell, deactivate the second protocol stack.

The instructions may, when individually or collectively executed by the one or more processors 120, cause the electronic device 101 to, based on the first protocol stack, access the third cell.

The instructions may, when individually or collectively executed by the one or more processors 120, cause the electronic device 101 to, based on accessing the third cell, stop camping on the second cell.

According to an example embodiment, a method for operating an electronic device (101) according to an example embodiment may be provided.

The operation method of the electronic device 101 may comprise, in a state in which a first subscriber identity module SIM is connected to the one or more processors 120, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The operation method of the electronic device 101 may comprise, based on accessing the first cell of the NTN, performing a scan using a second protocol stack different from the first protocol stack among the plurality of protocol stacks, in a state in which a SIM for the second protocol stack is not connected to the one or more processors.

The operation method of the electronic device 101 may comprise identifying a second cell of the TN.

The operation method of the electronic device 101 may comprise, based on a cell selection criterion associated with the second cell being satisfied in the state in which the SIM for the second protocol stack is not connected to the one or more processors, camping on the second cell by performing any cell selection associated with the second cell.

The operation method of the electronic device 101 may comprise, in a state in which the electronic device performs NTN communication based on the first cell and camps on the second cell, receiving, from the second cell, an emergency message by a network corresponding to the second cell.

According to an example embodiment, there may be provided a non-transitory computer-readable storage medium storing instructions.

The instructions may, when individually or collectively executed by one or more processors 120 of an electronic device 101, cause the electronic device 101 to, in a state in which a first subscriber identity module SIM is connected to the one or more processors 120, access a first cell of a non-terrestrial network (NTN) in which the electronic device 101 is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The instructions may, when individually or collectively executed by the one or more processors 120, cause the electronic device 101 to, based on accessing the first cell of the NTN, perform a scan using a second protocol stack different from the first protocol stack among the plurality of protocol stacks, in a state in which a SIM for the second protocol stack is not connected to the one or more processors 120.

The instructions may, when individually or collectively executed by the one or more processors 120, cause the electronic device 101 to, based on a result of the scan, identify a second cell of a terrestrial network (TN).

The instructions may, when individually or collectively executed by the one or more processors 120, cause the electronic device 101 to, based on a cell selection criterion associated with the second cell being satisfied in the state in which the SIM for the second protocol stack is not connected to the one or more processors 120, camp on the second cell by performing any cell selection associated with the second cell.

The instructions may, when individually or collectively executed by the one or more processors 120, cause the electronic device 101 to, in a state in which the electronic device performs NTN communication based on the first cell and camps on the second cell, receive, from the second cell, an emergency message by a network corresponding to the second cell.

According to an example embodiment, an electronic device 101 may comprise an embedded SIM 191, at least one processor, comprising processing circuitry 120 and memory 130 storing instructions.

The instructions may, when individually or collectively executed by the one or more processors 120, cause the electronic device 101 to, in a state in which a first SIM 111 is connected to the one or more processors 120 or a first profile based on the embedded SIM 191 is activated, access a first cell of a non-terrestrial network (NTN) in which the electronic device is capable of registering, using information stored in the first SIM or the first profile and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The instructions may, when individually or collectively executed by the one or more processors 120, cause the electronic device 101 to, based on accessing the first cell of the NTN, perform a scan using a second protocol stack different from the first protocol stack among the plurality of protocol stacks, in a state in which a profile for the second protocol stack is not activated based on the embedded SIM 191.

The instructions may, when individually or collectively executed by the one or more processors 120, cause the electronic device 101 to, based on a result of the scan, identify a second cell of a terrestrial network (TN).

The instructions may, when individually or collectively executed by the one or more processors 120, cause the electronic device 101 to, based on a cell selection criterion associated with the second cell being satisfied in the state in which the profile corresponding to the second cell is not activated based on the embedded SIM 191, camp on the second cell by performing any cell selection associated with the second cell.

The instructions may, when individually or collectively executed by the one or more processors 120, cause the electronic device 101 to, in a state in which the electronic device performs NTN communication based on the first cell and camps on the second cell, receive, from the second cell, an emergency message by a network corresponding to the second cell.

The instructions may, when individually or collectively executed by the one or more processors 120, cause the electronic device 101 to, in the state in which the electronic device performs the NTN communication based on the first cell and camps on the second cell, perform an emergency call based on the second cell.

The camp on the second cell may be performed before identification of a request for the emergency call.

The instructions may, when individually or collectively executed by the one or more processors 120, cause the electronic device 101, as at least part of performing the scan using the second protocol stack, to based on the identification of the request for the emergency call, perform the scan using the second protocol stack.

The instructions may, when individually or collectively executed by the one or more processors 120, cause the electronic device 101, to, as at least part of performing the emergency call based on the second cell, based on identifying that the emergency call is not supported by the first cell of the NTN, perform the emergency call based on the second cell.

The instructions may, when individually or collectively executed by the one or more processors 120, cause the electronic device 101 to, by referring to a network registration accept message based on the first cell, identify whether the emergency call is supported by the first cell of the NTN.

The instructions may, when individually or collectively executed by the one or more processors 120, cause the electronic device 101 to, based on a result of scan based on the first protocol stack, identify a third cell of the TN in which the electronic device 101 is capable of registering, in the state in which the electronic device 101 performs the NTN communication based on the first cell and camps on the second cell.

The instructions may, when individually or collectively executed by the one or more processors 120, cause the electronic device 101 to, based on the first protocol stack, access the third cell.

The instructions may, when individually or collectively executed by the one or more processors 120, cause the electronic device 101 to, based on accessing the third cell, stop camping on the second cell.

According to an example embodiment, a method for operating an electronic device 101 may be provided.

The operation method of the electronic device 101 may comprise, in a state in which a first SIM 111 is connected to the one or more processors 120 or a first profile based on the embedded SIM 191 is activated, accessing a first cell of a non-terrestrial network (NTN) in which the electronic device is capable of registering, using information stored in the first SIM or the first profile and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The operation method of the electronic device 101 may comprise, based on accessing the first cell of the NTN, performing a scan using a second protocol stack different from the first protocol stack among the plurality of protocol stacks, in a state in which a profile for the second protocol stack is not activated based on the embedded SIM 191.

The operation method of the electronic device 101 may comprise identifying a second cell of the TN.

The operation method of the electronic device 101 may comprise, based on a cell selection criterion associated with the second cell being satisfied in the state in which a profile corresponding to the second cell is not activated based on the embedded SIM 191, camping on the second cell by performing any cell selection associated with the second cell.

The operation method of the electronic device 101 may comprise, in a state in which the electronic device performs NTN communication based on the first cell and camps on the second cell, receiving, from the second cell, an emergency message by a network corresponding to the second cell.

According to an example embodiment, there may be provided a non-transitory computer-readable storage medium storing instructions.

The instructions may, when individually or collectively executed by one or more processors 120 of an electronic device 101, cause the electronic device 101 to, in a state in which a first SIM 111 is connected to the one or more processors 120 or a first profile based on the embedded SIM 191 is activated, access a first cell of a non-terrestrial network (NTN) in which the electronic device is capable of registering, using information stored in the first SIM or the first profile and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. Provision of an emergency message based on the first cell of the NTN may not be supported.

The instructions may, when individually or collectively executed by the one or more processors 120, cause the electronic device 101 to, based on accessing the first cell of the NTN, perform a scan using a second protocol stack different from the first protocol stack among the plurality of protocol stacks, in a state in which a profile for the second protocol stack is not activated based on the embedded SIM 191.

The instructions may, when individually or collectively executed by the one or more processors 120, cause the electronic device 101 to, based on a result of the scan, identify a second cell of a terrestrial network (TN).

The instructions may, when individually or collectively executed by the one or more processors 120, cause the electronic device 101 to, based on a cell selection criterion associated with the second cell being satisfied in the state in which the profile corresponding to the second cell is not activated based on the embedded SIM 191, camp on the second cell by performing any cell selection associated with the second cell.

The instructions may, when individually or collectively executed by the one or more processors 120, cause the electronic device 101 to, in a state in which the electronic device performs NTN communication based on the first cell and camps on the second cell, receive, from the second cell, an emergency message by a network corresponding to the second cell.

According to an example embodiment, an electronic device 101 may comprise at least one processor, comprising processing circuitry 120, and memory 130 storing instructions.

The instructions may, when individually or collectively executed by the one or more processors 120, cause the electronic device 101 to, in a state in which a first subscriber identity module SIM is connected to the one or more processors 120, access a first cell of a non-terrestrial network (NTN) in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. An emergency call based on the first cell of the NTN may not be supported.

The instructions may, when individually or collectively executed by the one or more processors 120, cause the electronic device 101 to, based on accessing the first cell of the NTN, perform a scan using a second protocol stack different from the first protocol stack among the plurality of protocol stacks, in a state in which a SIM for the second protocol stack is not connected to the one or more processors 120.

The instructions may, when individually or collectively executed by the one or more processors 120, cause the electronic device 101 to, based on a result of the scan, identify a second cell of a terrestrial network (TN).

The instructions may, when individually or collectively executed by the one or more processors 120, cause the electronic device 101 to, based on a cell selection criterion associated with the second cell being satisfied in the state in which the SIM for the second protocol stack is not connected to the one or more processors 120, camp on the second cell by performing any cell selection associated with the second cell.

The instructions may, when individually or collectively executed by the one or more processors 120, cause the electronic device 101 to, in the state in which the electronic device performs the NTN communication based on the first cell and camps on the second cell, perform the emergency call based on the second cell.

The camp on the second cell may be performed before identification of a request for the emergency call.

The instructions may, when individually or collectively executed by the one or more processors 120, cause the electronic device 101, to, as at least part of performing the scan using the second protocol stack, based on the identification of the request for the emergency call, perform the scan using the second protocol stack.

The instructions may, when individually or collectively executed by the one or more processors 120, cause the electronic device 101, to, as at least part of performing the emergency call based on the second cell, based on identifying that the emergency call is not supported by the first cell of the NTN, perform the emergency call based on the second cell.

The instructions may, when individually or collectively executed by the one or more processors 120, cause the electronic device 101 to, by referring to a network registration accept message based on the first cell, identify whether the emergency call is supported by the first cell of the NTN.

The instructions may, when individually or collectively executed by the one or more processors 120, cause the electronic device 101 to, based on a result of scan based on the first protocol stack, identify a third cell of the TN in which the electronic device 101 is capable of registering, in the state in which the electronic device 101 performs the NTN communication based on the first cell and camps on the second cell.

The instructions may, when individually or collectively executed by the one or more processors 120, cause the electronic device 101 to, based on the first protocol stack, access the third cell.

The instructions may, when individually or collectively executed by the one or more processors 120, cause the electronic device 101 to, based on accessing the third cell, stop camping on the second cell.

According to an example embodiment, a method for operating an electronic device 101 may be provided.

The operation method of the electronic device 101 may comprise, in a state in which a first subscriber identity module SIM is connected to the one or more processors 120, access a first cell of a non-terrestrial network NTN in which the electronic device is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. An emergency call based on the first cell of the NTN may not be supported.

The operation method of the electronic device 101 may comprise, based on accessing the first cell of the NTN, performing a scan using a second protocol stack different from the first protocol stack among the plurality of protocol stacks, in a state in which a SIM for the second protocol stack is not connected to the one or more processors.

The operation method of the electronic device 101 may comprise identifying a second cell of the TN.

The operation method of the electronic device 101 may comprise, based on a cell selection criterion associated with the second cell being satisfied in the state in which the SIM for the second protocol stack is not connected to the one or more processors, camping on the second cell by performing any cell selection associated with the second cell.

The operation method of the electronic device 101 may comprise, in the state in which the electronic device performs the NTN communication based on the first cell and camps on the second cell, performing the emergency call based on the second cell.

According to an example embodiment, there may be provided a non-transitory computer-readable storage medium storing instructions.

The instructions may, when individually or collectively executed by one or more processors 120 of an electronic device 101, cause the electronic device 101 to, in a state in which a first subscriber identity module SIM is connected to the one or more processors 120, access a first cell of a non-terrestrial network NTN in which the electronic device 101 is capable of registering, using information stored in the first SIM and a first protocol stack among a plurality of protocol stacks for a plurality of SIMs.

Before accessing the first cell of the NTN, based on not identifying that connection of a SIM associated with a remaining protocol stack except for the first protocol stack among the plurality of protocol stacks, an operation associated with the remaining protocol stack may be deactivated. An emergency call based on the first cell of the NTN may not be supported.

The instructions may, when individually or collectively executed by the one or more processors 120, cause the electronic device 101 to, based on accessing the first cell of the NTN, perform a scan using a second protocol stack different from the first protocol stack among the plurality of protocol stacks, in a state in which a SIM for the second protocol stack is not connected to the one or more processors 120.

The instructions may, when individually or collectively executed by the one or more processors 120, cause the electronic device 101 to, based on a result of the scan, identify a second cell of a terrestrial network (TN).

The instructions may, when individually or collectively executed by the one or more processors 120, cause the electronic device 101 to, based on a cell selection criterion associated with the second cell being satisfied in the state in which the SIM for the second protocol stack is not connected to the one or more processors 120, camp on the second cell by performing any cell selection associated with the second cell.

The instructions may, when individually or collectively executed by the one or more processors 120, cause the electronic device 101 to, in the state in which the electronic device performs the NTN communication based on the first cell and camps on the second cell, perform the emergency call based on the second cell.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor, comprising processing circuitry; and
memory storing instructions,
wherein at least one processor, individually and/or collectively, is configured to execute the instructions and to cause the electronic device to:
in a state in which a first subscriber identity module (SIM) is connected to at least one processor, access a first cell of a non-terrestrial network (NTN) in which the electronic device is capable of registering, using information stored in the first SIM and a first protocol stack among a plurality of protocol stacks for a plurality of SIMs, wherein, before accessing the first cell of the NTN, based on not identifying that connection of a SIM associated with a remaining protocol stack except for the first protocol stack among the plurality of protocol stacks, an operation associated with the remaining protocol stack is deactivated, wherein provision of an emergency message based on the first cell of the NTN is not supported,
based on accessing the first cell of the NTN, perform a scan using a second protocol stack different from the first protocol stack among the plurality of protocol stacks, in a state in which a SIM for the second protocol stack is not connected to the one or more processors,
based on a result of the scan, identify a second cell of a terrestrial network (TN),
based on a cell selection criterion associated with the second cell being satisfied in the state in which the SIM for the second protocol stack is not connected to at least one processor, camp on the second cell by performing any cell selection associated with the second cell, and
in a state in which the electronic device performs NTN communication based on the first cell and camps on the second cell, receive, from the second cell, an emergency message by a network corresponding to the second cell.

2. The electronic device of claim 1, wherein at least one processor, individually and/or collectively, is configured to cause the electronic device to:
in the state in which the electronic device performs the NTN communication based on the first cell and camps on the second cell, perform an emergency call based on the second cell.

3. The electronic device or claim 2, wherein the camp on the second cell is performed before identification of a request for the emergency call.

4. The electronic device of claim 1, wherein at least one processor, individually and/or collectively, is configured to cause the electronic device to:
based on the identification of the request for the emergency call, perform the scan using the second protocol stack.

5. The electronic device of claim 1, wherein at least one processor, individually and/or collectively, is configured to cause the electronic device to:
based on identifying that the emergency call is not supported by the first cell of the NTN, perform the emergency call based on the second cell.

6. The electronic device of claim 1, wherein at least one processor, individually and/or collectively, is configured to cause the electronic device to:
by referring to a network registration accept message based on the first cell, identify whether the emergency call is supported by the first cell of the NTN.

7. The electronic device of claim 1, wherein at least one processor, individually and/or collectively, is configured to cause the electronic device to:
based on a result of scan based on the first protocol stack, identify a third cell of the TN in which the electronic device is capable of registering, in the state in which the electronic device performs the NTN communication based on the first cell and camps on the second cell,
based on the first protocol stack, access the third cell, and
based on accessing the third cell, stop camping on the second cell.

8. The electronic device of claim 7, wherein at least one processor, individually and/or collectively, is configured to cause the electronic device to:
based on accessing the third cell, deactivate the second protocol stack.

9. An electronic device comprising:
an embedded subscriber identification module (SIM);
at least one processor, comprising processing circuitry; and
memory storing instructions, wherein at least one processor, individually and/or collectively, is configured to execute the instructions and to cause the electronic device to:
in a state in which a first subscriber identification module (SIM) is connected to at least one processor or a first profile based on the embedded SIM is activated, access a first cell of a non-terrestrial network (NTN) in which the electronic device is capable of registering, using information stored in the first SIM or the first profile and a first protocol stack among a plurality of protocol stacks for a plurality of SIMs, wherein, before accessing the first cell of the NTN, based on not identifying that connection of a SIM associated with a remaining protocol stack except for the first protocol stack among the plurality of protocol stacks, an operation associated with the remaining protocol stack is deactivated, wherein provision of an emergency message based on the first cell of the NTN is not supported,
based on accessing the first cell of the NTN, perform a scan using a second protocol stack different from the first protocol stack among the plurality of protocol stacks, in a state in which a profile for the second protocol stack is not activated based on the embedded SIM,
based on a result of the scan, identify a second cell of a terrestrial network (TN),
based on a cell selection criterion associated with the second cell being satisfied in the state in which a profile corresponding to the second cell is not activated based on the embedded SIM, camp on the second cell by performing any cell selection associated with the second cell, and
in a state in which the electronic device performs NTN communication based on the first cell and camps on the second cell, receive, from the second cell, an emergency message by a network corresponding to the second cell.

10. The electronic device of claim 9, wherein at least one processor, individually and/or collectively, is configured to cause the electronic device to:
in the state in which the electronic device performs the NTN communication based on the first cell and camps on the second cell, perform an emergency call based on the second cell.

11. The electronic device of claim 10, wherein the camp on the second cell is performed before identification of a request for the emergency call.

12. The electronic device of claim 9, wherein at least one processor, individually and/or collectively, is configured to cause the electronic device to:
based on the identification of the request for the emergency call, perform the scan using the second protocol stack.

13. The electronic device of claim 9, wherein at least one processor, individually and/or collectively, is configured to cause the electronic device to:
based on identifying that the emergency call is not supported by the first cell of the NTN, perform the emergency call based on the second cell.

14. The electronic device of claim 9, wherein at least one processor, individually and/or collectively, is configured to cause the electronic device to:
by referring to a network registration accept message based on the first cell, identify whether the emergency call is supported by the first cell of the NTN.

15. The electronic device of claim 9, wherein at least one processor, individually and/or collectively, is configured to cause the electronic device to:
based on a result of scan based on the first protocol stack, identify a third cell of the TN in which the electronic device is capable of registering, in the state in which the electronic device performs the NTN communication based on the first cell and camps on the second cell,
based on the first protocol stack, access the third cell, and
based on accessing the third cell, stop camping on the second cell.

16. The electronic device of claim 15, wherein at least one processor, individually and/or collectively, is configured to cause the electronic device to:
based on accessing the third cell, deactivate the second protocol stack.

17. An electronic device, comprising:
at least one processor comprising processing circuitry; and
memory storing instructions, wherein at least one processor, individually and/or collectively, is configured to execute the instructions and to cause the electronic device to:
in a state in which a first SIM is connected to at least one processor or a first profile based on a embedded subscriber identification module (SIM) is activated, access a first cell of a non-terrestrial network (NTN) in which the electronic device is capable of registering, using information stored in the first SIM or the first profile and a first protocol stack among a plurality of protocol stacks for a plurality of SIMs, wherein, before accessing the first cell of the NTN, based on not identifying that connection of a SIM associated with a remaining protocol stack except for the first protocol stack among the plurality of protocol stacks, an operation associated with the remaining protocol stack is deactivated, wherein an emergency call based on the first cell of the NTN is not supported,
based on accessing the first cell of the NTN, perform a scan using a second protocol stack different from the first protocol stack among the plurality of protocol stacks, in a state in which a profile for the second protocol stack is not activated based on the embedded SIM,
based on a result of the scan, identify a second cell of a terrestrial network (TN),
based on a cell selection criterion associated with the second cell being satisfied in the state in which a profile corresponding to the second cell is not activated based on the embedded SIM, camp on the second cell by performing any cell selection associated with the second cell, and
in the state in which the electronic device performs the NTN communication based on the first cell and camps on the second cell, perform the emergency call based on the second cell.

18. The electronic device of claim 17, wherein the camp on the second cell is performed before identification of a request for the emergency call.

19. The electronic device claim 18, wherein at least one processor, individually and/or collectively, is configured to cause the electronic device to:
based on the identification of the request for the emergency call, perform the scan using the second protocol stack.

20. The electronic device of claim 17, wherein at least one processor, individually and/or collectively, is configured to cause the electronic device to:
based on identifying that the emergency call is not supported by the first cell of the NTN, perform the emergency call based on the second cell.
